(19) United States
(12) Patent Application Publication
(10) Pub. No.: US 2024/0343384 A1
(43) Pub. Date: Oct. 17, 2024

(54) AIRCRAFT LANDING GEAR CONFIGURATIONS FOR TRANSFERRING LOADS TO FUSELAGE

(71) Applicant: ZSM HOLDINGS, INC., Dover, DE (US)

(72) Inventors: Jason C. Bell, Frederick, CO (US); Blake Poe, Longmont, CO (US); Etan D. Karni, Boulder, CO (US)

(21) Appl. No.: 18/294,534

(22) PCT Filed: Aug. 3, 2022
(86) PCT No.: PCT/US2022/039348

§ 371 Date: Feb. 1, 2024

Related U.S. Application Data
(60) Provisional application No. 63/229,043, filed on Aug. 3, 2021.

(51) Int. Cl. B64C 25/20; B64C 25/36

(52) U.S. Cl. CPC B64C 25/20; B64C 25/36

(57) ABSTRACT

A landing gear system for an aircraft includes a drag brace, a lateral brace, and a support assembly, the support assembly coupled to: a lateral side of the fuselage via the lateral brace, an upper portion of the fuselage via a hinge, and a forward portion of the fuselage via the drag brace. The support assembly can rotate about the hinge connection about a forward-aft axis, with the lateral brace resisting rotation of the support assembly about the forward-aft axis, and the drag brace resisting rotation of the support assembly about a vertical axis. The system includes inboard and outboard landing gear separately coupled to the support assembly to support weight of the aircraft. The hinge transfers vertical forces to the fuselage, moments about the hinge are reacted by forces on the lateral brace, and drag forces are transferred to the fuselage by the drag brace.

### CROSS-REFERENCE TO RELATED APPLICATIONS

This application claims priority to and the benefit of U.S. Provisional Application Ser. No. 63/229,043, entitled “AIRCRAFT LANDING GEAR CONFIGURATIONS WITH ROCKER ASSEMBLY FOR TRANSFERRING LOADS TO FUSELAGE,” and filed Aug. 3, 2021, the contents of which is incorporated by reference herein in its entirety.

### FIELD

The present disclosure relates to fuselage designs for cargo aircraft, and more particularly to landing gear designs that attach a main landing gear system to the side of a body of an airplane fuselage with an assembly that transfers primary landing loads via a single-axis hinge.

### BACKGROUND

Increases in global demand for wind energy has catalyzed the development of larger, better-performing wind turbines, as turbines with larger rotor diameters generally capture more wind energy. As turbines continue to improve, wind farm sites in previously undeveloped or underdeveloped locations become viable both onshore and offshore, including existing sites where older turbines need replacement.

A limiting factor to allow for the revitalization of old sites and development of new sites is transporting the wind turbines, and related equipment, to the sites. Wind turbine blades are difficult to transport long distances due to the terrestrial limitations of existing air vehicles and roadway infrastructures. Whether onshore or offshore, the road vehicle or ship options for transporting such equipment has become more limited, particularly as the size of wind turbines increase. The very long lengths of wind turbine blades (some are presently over 100 meters long and over 5 meters in chord) make conventional transportation by train, truck, or ship very difficult. Unfortunately, the solution is not as simple as making vehicles longer and/or larger; a variety of complications present themselves as vehicles are made longer and/or larger, including but not limited to: load balancing of the vehicle, the payload, and/or the two with respect to each other; handling, maneuverability, and control of the vehicle; limitations on ways by which the blades can be transported (e.g., limitations on the network of roads able to have vehicles transporting large, long payloads on them, needing multiple vehicles to drive in coordination for large payloads, among other complications associated with transporting blades, towers, and related wind turbine components onshore) and other complications apparent to those skilled in the art. Moreover, even with expanded terrestrial infrastructure (e.g., larger roads, higher overpasses), serious complications remain, such as the necessity of coordinating multiple vehicles to transport a single object (e.g., a 100 meter long wind turbine blade) and/or the ability to even rotate such a cargo to conduct a turning maneuver.

Further, whether onshore or offshore, delivery of parts can be slow and severely limited by the accessibility of the site. Wind farm sites are often remote, and thus not near suitable transportation infrastructure, and new sites are often without any existing transportation infrastructure, thus requiring new construction and special equipment. Ultimately, transportation logistics become cost prohibitive, resulting in a literal and figurative roadblock to further advancing the use of wind energy on a global scale.

Existing cargo aircraft, including the largest aircraft ever to fly, are not able to transport extremely large cargo, even if that cargo is, in all dimensions, smaller than the aircraft itself. This limitation is often the result of cargo aircraft, even those purpose built to be cargo aircraft, not fully utilizing their overall size as cargo bay volume. This constraint has many causes, one of which is related the need for aircraft to have large main landing gear assemblies that can be retracted and stowed inside the fuselage during flight. The need to reserve space for large landing gear assemblies can negatively impact the overall cargo volume available.

Accordingly, there is a need for large, transport-category aircraft landing gear designs that minimally impact available cargo volume inside the aircraft.

### SUMMARY

Certain examples of the present disclosure include a main landing gear design for increasing the useable interior cargo bay of a cargo aircraft and/or extending the width and outboard reach of main landing gear assemblies. Examples of the present disclosure include extremely large cargo aircraft capable of both carrying extremely long payloads and being able to take off and land at runways that are significantly shorter than those required by most, if not all, existing large aircraft. For purposes of the present disclosure, a large or long aircraft is considered an aircraft having a fuselage length from fuselage nose tip to fuselage tail tip that is at least approximately 60 meters long. The American Federal Aviation Administration (FAA) defines a large aircraft as any aircraft of more than 12,500 pounds maximum certificated takeoff weight, which can also be considered a large aircraft in the present context, but the focus of size is generally related to a length of the aircraft herein. One example of such an oversized payload capable of being transported using examples of this present disclosure are wind turbine blades, the largest of which can be over 100 meters in length. Examples of the present disclosure enable a payload of such an extreme length to be transported within the cargo bay of an aircraft having a fuselage length only slighter longer than the payload, while that aircraft can also take off and land at most existing commercial airports, as well as runways that are even smaller, for instance because they are built at a desired location for landing such cargo aircraft near a site where the cargo is to be used, such as a landing strip built near or as part of a wind farm.

Examples of the present disclosure also include a means to structurally couple a main landing gear system to the side of body of an airplane fuselage. One example is a drag brace that enables landing gear to be wider and/or positioned further outboard from the fuselage body by reacting the drag forces from the outermost wheels directly to the fuselage at a structurally ideal location. Additionally, whereas most landing gear systems attach directly to the primary fuselage airframe structure, other examples of the present disclosure include interface structures between the main landing gear system and the primary airframe fuselage structure. An example of an interface structure is a torque box to which landing gear assemblies are secured and which is coupled to the structural fuselage of the aircraft by both a single-axis hinge as well as a static linkage. The single-axis hinge permits rotation of the torque box along an axis parallel to the side of the aircraft where the hinge connects the fuselage to the torque box. The static linkage reacts any moments about the hinge axis via forces acting into the fuselage at a position where an angle between the linkage and the fuselage skin (or the length of a transverse frame element) is minimized or at least less than the same angle at a location proximate to the torque box. Accordingly, the static linkage prevents rotation of the torque box about the hinge and reacts moments about the hinge via forces that are delivered to the fuselage at structurally-ideal locations.

For example, consider a torque box located substantially outboard of the fuselage, with the single-axis hinge is at the upper end of a torque box and coupled to the lateral side of the fuselage to react 3-axis forces from the landing gear assemblies into the side of the fuselage. Any forces, especially vertical forces offset from the hinge will create a moment about the hinge, but the fuselage skin and transverse frames proximate to the outboard location of the torque box are substantially perpendicular to any force vector that reacts the moment about the hinge. Because the fuselage skin and transverse frames are much stronger in parallel loading (e.g., in plan with the skin) than perpendicular loading (e.g., normal to the skin) the static linkage is connected to, for example, a lower side or bottom side of the fuselage where the fuselage skin and transverse frames are approximately horizontal and/or parallel to a force vector that reacts the moment about the hinge.

Examples of the present disclosure advantageously enables landing gear assemblies to be arranged farther outboard from the fuselage and thereby reduce the amount of an interior cargo bay that is taken up by the wheel well. For example, a torque box can be arranged substantially outboard from the side of the fuselage such that normal landing loads generate movements about the hinge, and the static linkage reacts those moments with forces delivered to the fuselage at structurally favorable locations (e.g., at a lower side of the fuselage).

One example of the present disclosure is an aircraft that includes a fuselage, a landing gear system with a drag brace, a lateral brace, and a support assembly that has a lateral support element configured to separately carry an inboard landing gear and an outboard landing gear arranged in parallel when in a deployed configuration. The support assembly is: (i) coupled with the fuselage at an upper location with respect to the landing gear system via an upper hinged connection; (ii) coupled with the fuselage at a lateral location with respect to the landing gear system via the lateral brace; and (iii) coupled with the fuselage at a forward location with respect to the landing gear system via the drag brace. The drag brace is coupled with the support assembly outboard of a connection between the lateral support element and the inboard landing gear. The support assembly is configured to rotate about the upper hinged connection about a forward-aft axis. The lateral brace is configured to resist rotation of the support assembly about the forward-aft axis. Further, the drag brace is configured to resist rotation of the support assembly about a vertical axis.

The drag brace can be coupled with the support assembly outboard of a connection between the lateral support element and the inboard landing gear. The drag brace can be configured to resist rotation of the lateral support element about the vertical axis such that the longitudinal forces on the inboard and outboard landing gear result do not induce a vertical moment about the upper connection. The drag brace can be configured to resist rotation of the support assembly about the vertical axis such that an outboard end of the lateral support element can be prevented from moving forward or aft.

The support assembly can be configured to react vertical forces from the inboard and outboard landing gears to the fuselage, wherein the lateral brace can be configured to react lateral forces from the inboard and outboard landing gears to the fuselage, and wherein the drag brace can be configured to react longitudinal forces from the outboard landing gear to the fuselage. When carried by the support assembly, the outboard landing gear can include at least one wheel positioned outboard of the upper location. When carried by the support assembly, the inboard and outboard landing gears can each include at least two separate wheels positioned in parallel. The lateral support element can be arranged such that longitudinal forces on the outboard landing gear can create a moment about the vertical axis that can be resisted by the drag brace. The drag brace can be coupled with an outboard end of the lateral support element. The landing gear system can be configured to move the support assembly between a stowed position and the deployed position. The lateral support element can include an upper support and kneeling support moveably coupled with the upper support. The kneeling support can be configured to separately carry the inboard landing gear and the outboard landing gear and can be moveable with respect to the upper support to move the inboard and outboard landing gears between the deployed configuration and a partially-stowed configuration. The support assembly can include a forward lateral support element and an aft lateral support element. The forward lateral support element can be configured to react forces from the inboard and outboard landing gear assemblies, and the aft lateral support element can be configured to react forces from a second inboard landing gear assembly. A second outboard landing gear assembly can be separately carried by the aft lateral support element. The support assembly further can include a longitudinal support element that can couple the aft lateral support element to the forward lateral support element such that the forward and aft lateral support element rotate together about parallel respective vertical axes.

Another example is an aircraft, including a fuselage a landing gear system including a drag brace, a lateral brace, and a support assembly with lateral support element. The lateral support element is configured to separately carry an inboard landing gear and an outboard landing gear arranged in parallel when in a deployed configuration. The support assembly is: (i) coupled with the fuselage at an upper location with respect to the landing gear system via an upper connection; and (ii) coupled with the fuselage at a forward location with respect to the landing gear system via the drag brace. The drag brace is coupled with the lateral support element outboard of a connection between the lateral support element and the outboard landing gear. Further, the drag brace is configured to resist rotation of the lateral support element about a vertical axis such that the longitudinal forces on the inboard and outboard landing gear result do not induce a vertical moment about the upper connection.

Yet another example of the present disclosure is a landing gear system for an aircraft including a drag brace, a lateral brace, a support assembly, an inboard landing gear, and an outboard landing gear. The support assembly includes a upper hinge and a lateral support element, and is configured to be coupled to a fuselage of an aircraft via the upper hinge, the drag brace, and the lateral brace. The inboard landing gear is coupled with the lateral support element and is configured to support at least a portion of the weight of the aircraft. The outboard landing gear is separately coupled with the lateral support element and is configured to support at least a portion of the weight of the aircraft. The support assembly is configured to, in a deployed configuration, rotate about a forward-aft axis of the upper hinge with respect to the lateral side of the fuselage and react vertical forces from the inboard and outboard landing gears to the fuselage. The lateral brace is configured to, in a deployed configuration, statically couple the support assembly to the fuselage such that rotation of the support assembly about the hinge can be resisted by the lateral brace and react lateral forces from the inboard and outboard landing gears to the fuselage. Further, the drag brace is configured to, in a deployed configuration, statically couple the support assembly to the fuselage such that rotation of the support assembly about a vertical axis can be resisted by the drag brace and react longitudinal forces from the outboard landing gear to the fuselage.

The drag brace can be configured to resist rotation of the support assembly about the vertical axis such that an outboard end of the lateral support element can be preventing from moving aftward. The support assembly can be configured to react vertical forces from the inboard and outboard landing gears to the fuselage, the lateral brace can be configured to react lateral forces from the inboard and outboard landing gears to the fuselage, and the drag brace can be configured to react longitudinal forces from the outboard landing gear to the fuselage. The outboard landing gear can include at least one wheel positioned outboard of the upper location. The inboard and outboard landing gears each include at least two separate wheels arranged in parallel. The lateral support element can be arranged such that longitudinal forces on the outboard landing gear create a moment of the lateral support element about the vertical axis that can be resisted by the drag brace. The drag brace can be coupled with an outboard end of the lateral support element.

The lateral support element can include an upper support and kneeling support moveably coupled with the upper support. In some such embodiments, the kneeling support can be configured to separately carry the inboard landing gear and the outboard landing gear and can be moveable with respect to the upper support to move the inboard and outboard landing gears between the deployed configuration and a partially stowed configuration. The support assembly can include a forward lateral support element and an aft lateral support element. The forward lateral support element can be configured to react forces from the inboard and outboard landing gear assemblies, and the aft lateral support element can be configured to react forces from a second inboard landing gear assembly and a second outboard landing gear assembly separately carried by the aft lateral support element. The support assembly further can include a longitudinal support element coupling the aft lateral support element to the forward lateral support element such that the forward and aft lateral support elements rotate together about parallel respective vertical axes.

Still another example is a cargo aircraft that includes a fuselage defining a forward end, an aft end, and a continuous interior cargo bay that spans a majority of a length of the fuselage from the forward end to the aft end, and a landing gear system. The landing gear system includes a drag brace, a lateral brace, and a support assembly, and the support assembly includes a lateral support element configured to separately carry an inboard landing gear and an outboard landing gear. Further, the support assembly is coupled with the fuselage via: (i) an upper hinged connection; (ii) the lateral brace; and (iii) the drag brace. The support assembly is configured to rotate about a forward-aft axis of the upper hinged connection. The lateral brace is configured to resist rotation of the support assembly about the upper hinged connection. The drag brace is configured to resist rotation of the support assembly about a vertical axis such that the longitudinal forces on the inboard and outboard landing gear result do not induce a vertical moment about the upper connection. Further, the upper hinged connection is configured to direct vertical loads from the support assembly into at least one of a skin of the fuselage or a transverse frame of the fuselage.

The landing gear system can be a first landing gear system and the aircraft can also include a second landing gear system. The first landing gear system can be arranged on a first lateral side of the cargo aircraft and the second landing gear system can be arranged on a second opposite lateral side of the cargo aircraft. The first landing gear system and the second landing gear system can together define at least a portion of a main landing gear of the cargo aircraft, the main landing gear being positioned closer to a center of gravity of the cargo aircraft than any other landing gear. The fuselage can include a forward portion containing a forward region of the continuous interior cargo bay and an aft portion containing an aft region of the continuous interior cargo bay. The forward portion can define a forward centerline along a longitudinal-lateral plane of the cargo aircraft, and the aft portion can define an aft centerline extending above the longitudinal-lateral plane of the cargo aircraft. The fuselage can also include, a kinked portion that can form a junction in the fuselage between the forward portion and the aft portion of the fuselage and between the forward and aft regions of the continuous interior cargo bay. The kinked portion can contain a transition region of the continuous interior cargo bay and can define a bend angle between the forward centerline and the aft centerline. In at least some such embodiments, the landing gear system can be located in the forward portion of the fuselage.

Still another example is an aircraft that includes a fuselage and a floating landing gear system. The floating landing gear system includes a torque box that is configured to support a landing gear assembly. The torque box is coupled with a lateral side of the fuselage via an upper hinged connection and is also coupled with a lower side of the fuselage via a lower static coupling. Further, the torque box is configured to rotate about a forward-aft axis of the upper hinged connection, and the lower static coupling is configured to resist rotation of the torque box about the upper hinged connection.

The floating landing gear system can include at least one landing gear assembly coupled with the torque box. The at least one landing gear assembly can include an outer landing gear assembly disposed laterally outside with respect to the hinge and an inner landing gear assembly disposed laterally inside with respect to the hinge. The at least one landing gear assembly can be configured to apply a combined vertical force to the torque box that can be laterally offset from a vertical location of the hinge. The upper hinged connection defines a single rotation axis that can be approximately parallel to the lateral side of the fuselage. The fuselage can include a landing gear wheel well formed in the lateral side of the fuselage, and at least an inner lateral end of the torque box can be disposed within the landing gear wheel well. The floating landing gear system can be a first floating landing gear system and the aircraft can include a second floating landing gear system. In at least some such embodiments, the first floating landing gear system can be arranged on a first lateral side of the aircraft and the second floating landing gear system can be arranged on a second opposite lateral side of the aircraft.

The first floating landing gear system and the second floating landing gear system can together define at least a portion of a main landing gear of the aircraft. The main landing gear can be positioned closer to a center of gravity of the aircraft than any other landing gear. The upper hinged connection can be configured to direct vertical forces from the torque box into the lateral side of the fuselage. The upper hinged connection can include a clevis fastener, which can be configured to transfer the vertical forces from the torque box into the lateral side of the fuselage. The clevis fastener can also be configured to transfer lateral forces from the torque box into the lateral side of the fuselage. The upper hinged connection can be configured to direct longitudinal forces from the torque box into the lateral side of the fuselage. The upper hinged connection can include a piano hinge element configured to transfer the longitudinal forces from the torque box into the lateral side of the fuselage. The lower static coupling can be configured to convert moments about the hinged connection into tangential forces on the skin of the fuselage and/or the transverse frame of the fuselage. The upper hinged connection can be configured to direct forces from the torque box into a skin of the lateral side of the fuselage and/or a transverse frame element of the lateral side of the fuselage. The lower static coupling can be configured to direct forces from the torque box into a skin of the lower side of the fuselage and/or a transverse frame element of the lower side of the fuselage. The static coupling element can include a tie-rod linkage. The hinge can be laterally offset from the static coupling element.

Another example is a cargo aircraft that includes a fuselage and a floating landing gear system. The fuselage defines a forward end, an aft end, and a continuous interior cargo bay that spans a majority of a length of the fuselage from the forward end to the aft end. The floating landing gear system includes a torque box configured to support a landing gear assembly. The torque box is coupled with a lateral side of the fuselage via an upper hinged connection and coupled with a lower side of the fuselage via a lower static coupling. The rocker is configured to rotate about the upper hinged connection, while the lower static coupling is configured to resist rotation of the torque box about the upper hinged connection. Further, the upper hinged connection is configured to direct vertical loads from the rocker into at least one of a skin of the fuselage or a transverse frame of the fuselage, and the lower static coupling is configured to convert moments about the hinged connection into tangential forces on at least one of the skin of the fuselage or the transverse frame of the fuselage.

The floating landing gear system can be a first floating landing gear system and the aircraft can include a second floating landing gear system. The first floating landing gear system can be arranged on a first lateral side of the cargo aircraft and the second floating landing gear system can be arranged on a second opposite lateral side of the cargo aircraft. The first floating landing gear system and the second floating landing gear system can together define at least a portion of a main landing gear of the cargo aircraft. The main landing gear can be positioned closer to a center of gravity of the cargo aircraft than any other landing gear. The fuselage can include a forward portion containing a forward region of the continuous interior cargo bay and an aft portion containing an aft region of the continuous interior cargo bay. The forward portion can define a forward centerline along a longitudinal-lateral plane of the cargo aircraft, and the aft portion can define an aft centerline extending above the longitudinal-lateral plane of the cargo aircraft. The fuselage can also include a kinked portion that can form a junction in the fuselage between the forward portion and the aft portion of the fuselage and between the forward and aft regions of the continuous interior cargo bay. The kinked portion can contain a transition region of the continuous interior cargo bay and can define a bend angle between the forward centerline and the aft centerline. In at least some such embodiments, the floating landing gear system can be located in the forward portion of the fuselage. The length of the fuselage can be greater than about 84 meters, and the continuous interior cargo bay can define a maximum payload length of at least about 70 meters.

Yet another example is a floating landing gear system for an aircraft that include a torque box and at least one landing gear assembly. The torque box includes a hinge and a static coupling element. The torque box is configured to be coupled to a lateral side of a fuselage of an aircraft via the hinge, and is also configured to be coupled to a lower side of the fuselage via the static coupling element. At least one landing gear assembly is coupled to the torque box and is configured to support at least a portion of the weight of the aircraft. Further, the torque box is configured to rotate about the hinge with respect to the lateral side of the fuselage. The static coupling element is configured to statically couple the torque box to the lower side of the fuselage such that rotation of the torque box about the hinge can be resisted by the static coupling element, and the hinge is configured to transfer vertical, lateral, and longitudinal forces from the at least one landing gear assembly to the lateral side of the fuselage.

The at least one landing gear assembly can be configured to apply a combined vertical force to the torque box that can be laterally offset from a vertical location of the hinge. The hinge can be configured to rotatably couple the torque box to the lateral side of the fuselage about a single axis approximately parallel to at least one of a longitudinal axis of the aircraft and/or the lateral side of the fuselage. The hinge can include a piano hinge or compliant flexure element configured to transfer the longitudinal forces from the at least one landing gear assembly to the lateral side of the fuselage. The hinge can include a clevis fastener configured to transfer the vertical and lateral forces from the at least one landing gear assembly to the lateral side of the fuselage. The hinge can be laterally offset from the static coupling element. The hinge can be disposed about an upper end of the torque box and the static coupling element can be disposed about a lower end of the torque box. The static coupling element can include a tie-rod linkage. The at least one landing gear assembly can include an outer landing gear assembly disposed laterally outside with respect to the hinge and an inner landing gear assembly disposed laterally inside with respect to the hinge. The at least one landing gear assembly can define a deployed configuration and a stowed configuration and the at least one landing gear assembly can be moveable between the deployed and stowed configurations.

### BRIEF DESCRIPTION OF DRAWINGS

This disclosure will be more fully understood from the following detailed description taken in conjunction with the accompanying drawings, in which:

FIG. 1A is an isometric view of one exemplary embodiment of an aircraft;

FIG. 1B is a side view of the aircraft of FIG. 1A;

FIG. 2A is an isometric view of the aircraft of FIG. 1A with a nose cone door in an open position to provide access to an interior cargo bay of the aircraft;

FIG. 2B is an isometric view of the aircraft of FIG. 2A with a payload being disposed proximate to the aircraft for loading into the interior cargo bay;

FIG. 2C is an isometric, transparent view of the aircraft of FIG. 1A having a payload disposed therein using a rail system;

FIG. 3 is a schematic side view of an aircraft in the prior art, illustrating a lateral axis of rotation with respect to tail strike;

FIG. 4 is a side view of an alternative exemplary embodiment of an aircraft;

FIG. 5 is a side view of the aircraft of FIG. 4 in a take-off position;

FIG. 6 is the side cross-sectional view of the aircraft of FIG. 1A with an exemplary payload disposed in the interior cargo bay;

FIG. 7 is an isometric view of the aircraft of FIG. 6 illustrating a lower support system that extends along the interior cargo bay from a forward entrance to an aft section of the interior cargo bay in an aft portion of a fuselage of the aircraft;

FIG. 8A is a side view of one exemplary embodiment of structural elements of a cargo aircraft fuselage;

FIG. 8B is an isometric view of the fuselage of FIG. 8A;

FIG. 9A is a rear view of a landing gear sponson design showing lateral asymmetry of vertical forces for each landing gear assembly with respect to the lateral side of the fuselage of FIG. 1A;

FIG. 9B is a front isometric view of the landing gear sponson of FIG. 9A showing external support bracing positioned in an undesirable locations;

FIG. 10 is a cross-sectional view of an example floating landing gear assembly structurally coupling individual landing gear assemblies to the fuselage inside the landing gear sponson of FIG. 9A, with the cross-section taken though A-A, as indicated in FIG. 9B;

FIG. 11A is an isometric view of an example of a floating landing gear assembly;

FIG. 11B is an isometric view of another example of a floating landing gear assembly with the hinge axis, applied moment, and reaction forces illustrated;

FIG. 11C is an isometric view of the floating landing gear assembly of FIG. 11A with the hinge reaction forces illustrated;

FIG. 11D is a detail isometric view of the upper hinge connection of the floating landing gear assembly of FIG. 11A;

FIG. 12A is an isometric view of the floating landing gear assembly of FIG. 11A with two sets of landing gear attached to a rocker torque box;

FIG. 12B is an isometric view of the floating landing gear assembly of FIG. 12B with the forces applied to the rocker torque box by an individual landing gear assembly illustrated;

FIG. 12C is a side view of the floating landing gear assembly of FIG. 11A with the forces applied to the fuselage by the rocker torque box illustrated;

FIG. 13 is an isometric view of a tie-rod connection between the lower fuselage and the rocker of the rocker torque box of FIG. 11A;

FIG. 14A is a front view of a portion of the aircraft of FIG. 9A without individual landing gear assemblies and showing the major forces applied to the fuselage by the rocker torque box during a landing operation;

FIG. 14B is a front view of a portion of the aircraft of FIG. 9A showing additional forces applied to the fuselage by the rocker torque box during operation of the aircraft;

FIG. 14C is a top-down cross-sectional view of a lower portion the aircraft of FIG. 9A showing additional forces applied to the fuselage by the rocker torque box during operation of the aircraft;

FIG. 15A is an outboard isometric view of an aircraft landing gear assembly having a drag brace;

FIG. 15B is an inboard isometric view of the aircraft landing gear assembly of FIG. 15A;

FIG. 15C is a rear isometric view of the aircraft landing gear assembly of FIG. 15A;

FIG. 16A is a side view schematic of an aircraft landing gear assembly having a drag brace;

FIG. 16B is a rear view schematic of the landing gear assembly of FIG. 16A;

FIG. 16C is a top view schematic of the landing gear assembly of FIG. 16A;

FIG. 16D is a top view schematic of another example aircraft landing gear assembly having dual twin landing gears;

FIG. 16E is a top view schematic of still another example aircraft landing gear assembly having dual twin tandem landing gears;

FIG. 16F is a top view schematic of yet another example aircraft landing gear assembly having dual twin tandem landing gears;

FIG. 16G is a top view schematic of an example aircraft landing gear assembly having a aft drag brace;

FIG. 17 is an isometric view of the of the aircraft landing gear assembly of FIG. 15A in an installed position with an aircraft fuselage section;

FIG. 18A is a front view of the landing gear assembly of FIG. 15A;

FIG. 18B is a top view of the landing gear assembly of FIG. 15A; and

FIG. 18C is a side view of the landing gear assembly of FIG. 15A;

### DETAILED DESCRIPTION

Certain exemplary embodiments will now be described to provide an overall understanding of the principles of the structure, function, manufacture, and use of the devices, systems, aircraft, and methods disclosed herein. One or more examples of these embodiments are illustrated in the accompanying drawings. Those skilled in the art will understand that the devices, systems, aircraft, components related to or otherwise part of such devices, systems, and aircraft, and methods specifically described herein and illustrated in the accompanying drawings are non-limiting embodiments and that the scope of the present disclosure is defined solely by the claims. The features illustrated or described in connection with one embodiment may be combined with the features of other embodiments. Such modifications and variations are intended to be included within the scope of the present disclosure. Some of the embodiments provided for herein may be schematic drawings, including possibly some that are not labeled as such but will be understood by a person skilled in the art to be schematic in nature. They may not be to scale or may be somewhat crude renderings of the disclosed components. A person skilled in the art will understand how to implement these teachings and incorporate them into working systems, methods, aircraft, and components related to each of the same, provided for herein.

To the extent the present disclosure includes various terms for components and/or processes of the disclosed devices, systems, aircraft, methods, and the like, one skilled in the art, in view of the claims, present disclosure, and knowledge of the skilled person, will understand such terms are merely examples of such components and/or processes, and other components, designs, processes, and/or actions are possible. By way of non-limiting example, while the present application describes loading an airplane through a front end of the aircraft, alternatively, or additionally, loading can occur through an aft end of the aircraft and/or from above and/or below and/or from the side of the aircraft. In the present disclosure, like-numbered and like-lettered components of various embodiments generally have similar features when those components are of a similar nature and/or serve a similar purpose. To the extent terms such as front, back, top, bottom, forward, aft, proximal, distal, etc. are used to describe a location of various components of the various disclosures, such usage is by no means limiting, and is often used for convenience when describing various possible configurations. The foregoing notwithstanding, a person skilled in the art will recognize the common vernacular used with respect to aircraft, such as the terms “forward” and “aft,” and will give terms of those nature their commonly understood meaning. Further in some instances, terms like forward and proximal or aft and distal may be used in a similar fashion.

The present disclosure is related to large, transport-category aircraft (e.g., fixed-wing, non-buoyant, and multi-engine aircraft), capable of moving oversized cargo not traditionally shippable by air. For example, wind turbine blades, which are typically highly elongated and irregular in shape to provide greater electrical power generating efficiency, or similarly long industrial equipment, shipping containers, or military equipment. The present disclosure is not limited to these specific cargos or payloads, but rather, these are examples. Examples of the present disclosure include extremely long cargo aircraft (e.g., longer than 60 meters, or even longer than 84 meters) with a kink in the fuselage about the lateral (pitch) axis, which allows for the transportation of long payloads or cargos while also meeting the tail strike requirement by allowing the cargo to extend longitudinally aft and upwards to locations that are vertically above the upper surface of the forwards fuselage.

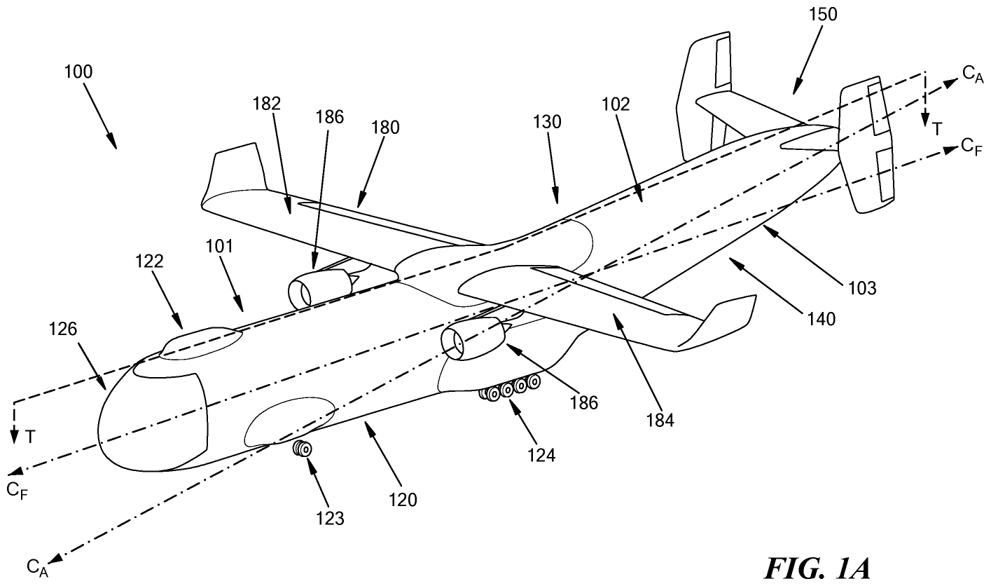

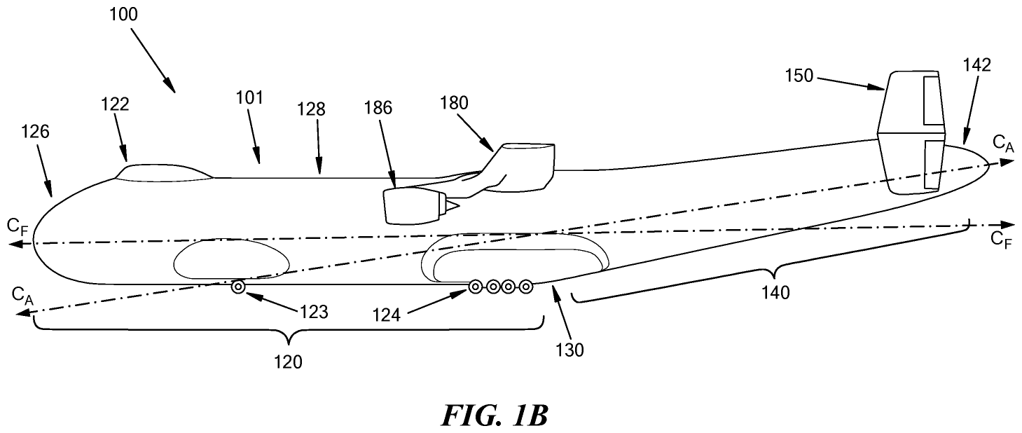

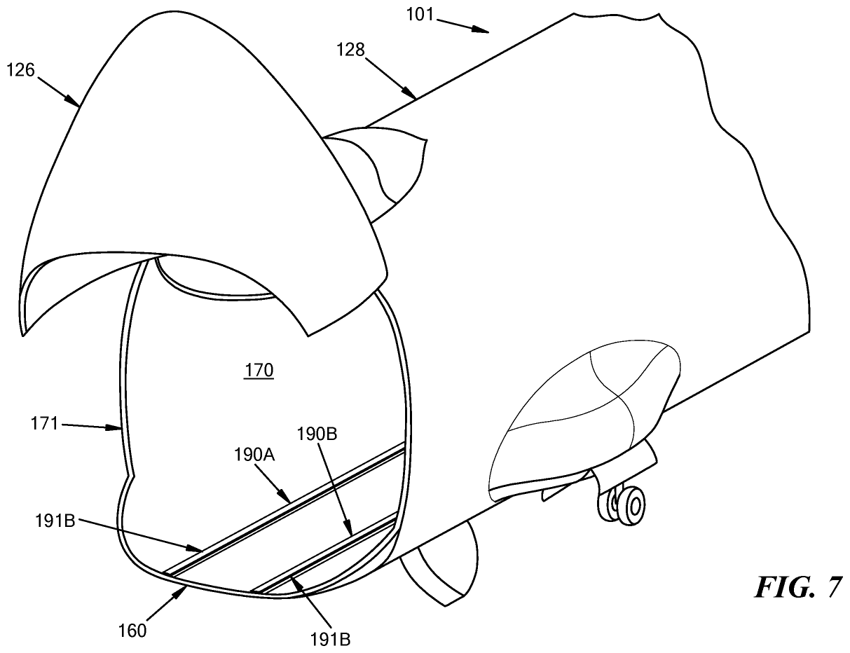

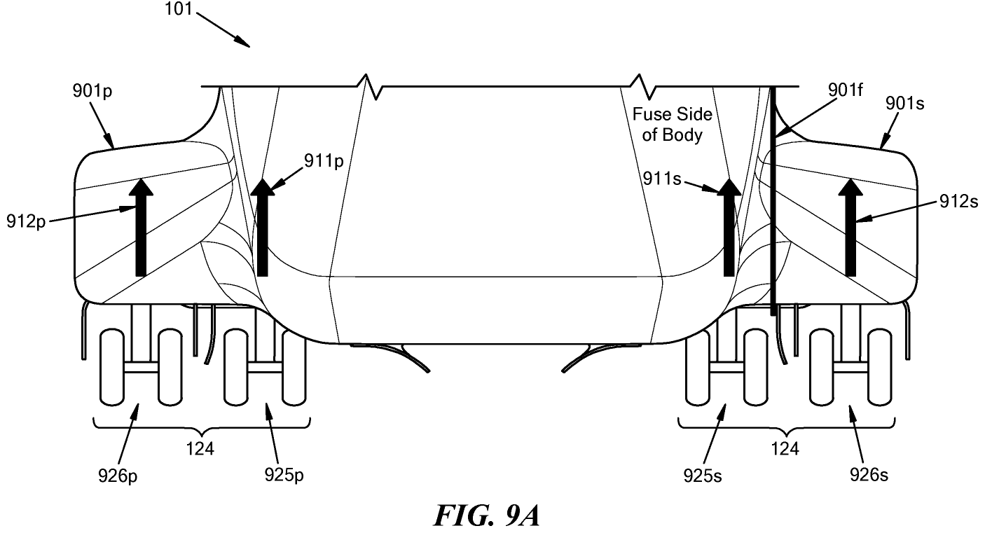

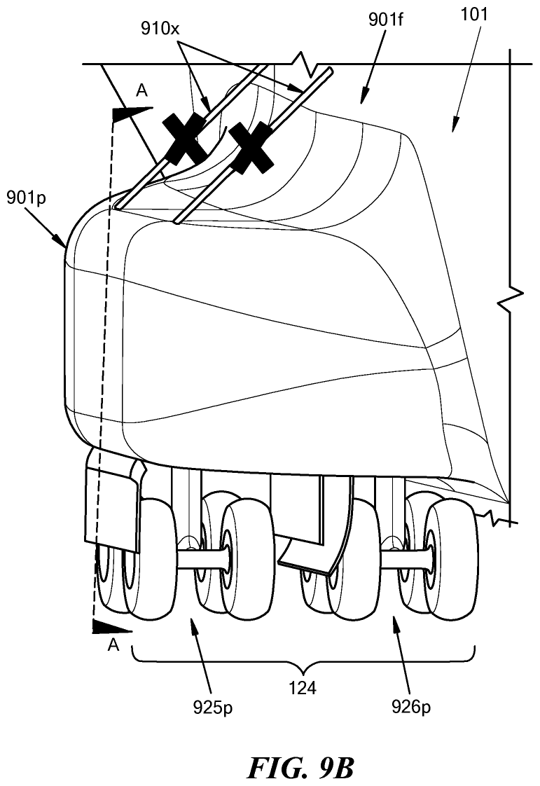

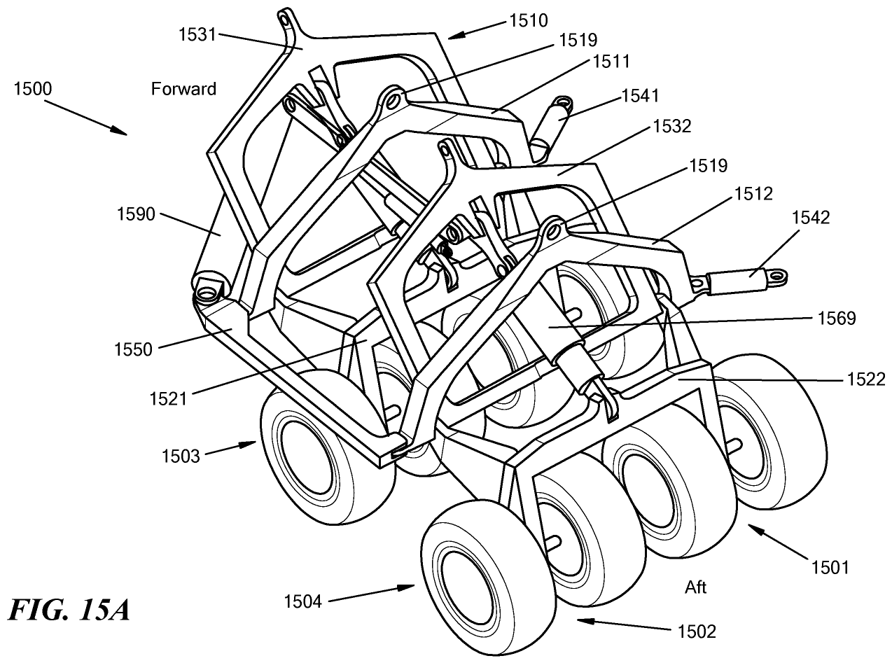

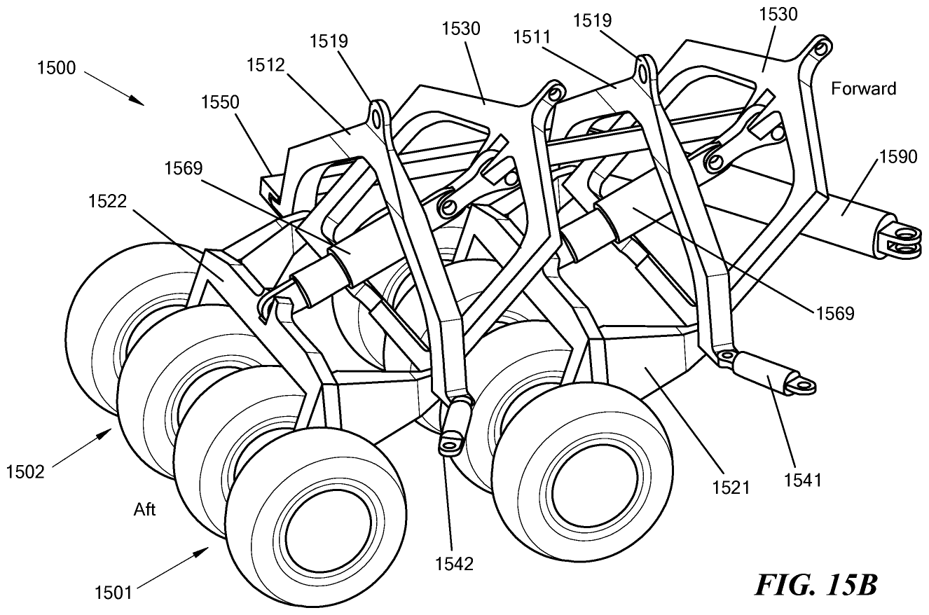

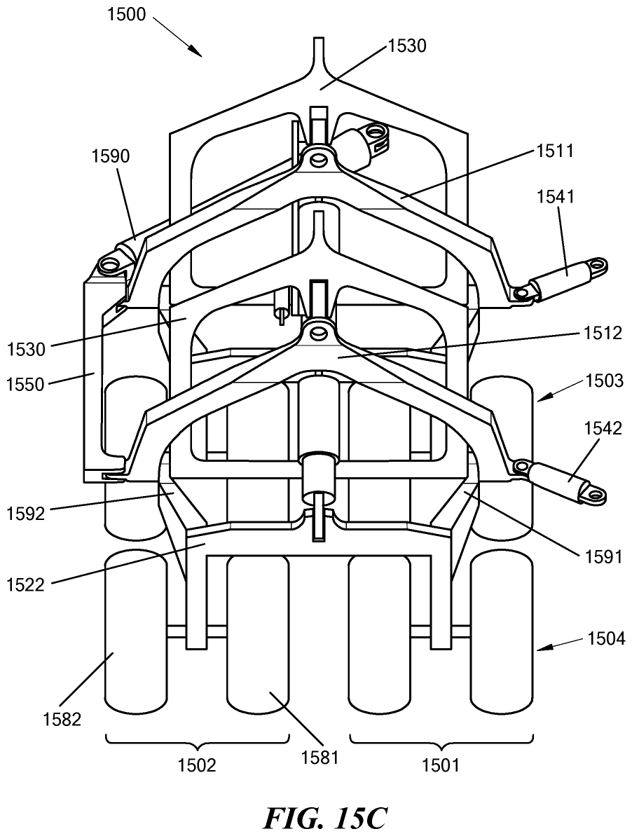

Fixed-wing aircraft traditionally support the vast majority of their weight on the ground and during landing with a port and starboard main landing gear assembly that are centrally located below and aft of the center of gravity of the aircraft. Large fixed high wing aircraft often position the port and starboard main landing gear assemblies at the outboard sides of the fuselage body to achieve a number of design objectives: (i) the main landing gear assemblies being able to be retracted into the fuselage; (ii) the port and starboard main landing gear assemblies being positioned wide enough to stabilize the aircraft in the roll axis during ground, takeoff, and landing operations; (iii) the main landing gear assemblies being located close enough to the fuselage to direct their primary vertical landing forces direct into the side of the fuselage; (iv) maximizing cargo volume; and (v) to add extra necessary main landing gear assemblies longitudinally along the fuselage to reduce the impact of the wheel well on the cross-sectional area of the cargo bay. All of these design objectives are inexorably tied to the desired structural loading of the fuselage by the main landing gear assemblies. Examples of the present disclosure provide a new main landing gear arrangement that enables landing gear assemblies to be moved further outboard without comprising the favorable structural interactions achieved by traditional designs. One such large high-wing cargo aircraft suitable for use with aspects of the present disclosure with short is illustrated in FIGS. 1A and 7, with detailed illustration of examples of a new floating main landing gear system in FIGS. 9A-14C, and detailed illustration of examples of a new main landing gear system with an outboard drag brace in FIGS. 15A-18C.

### Aircraft

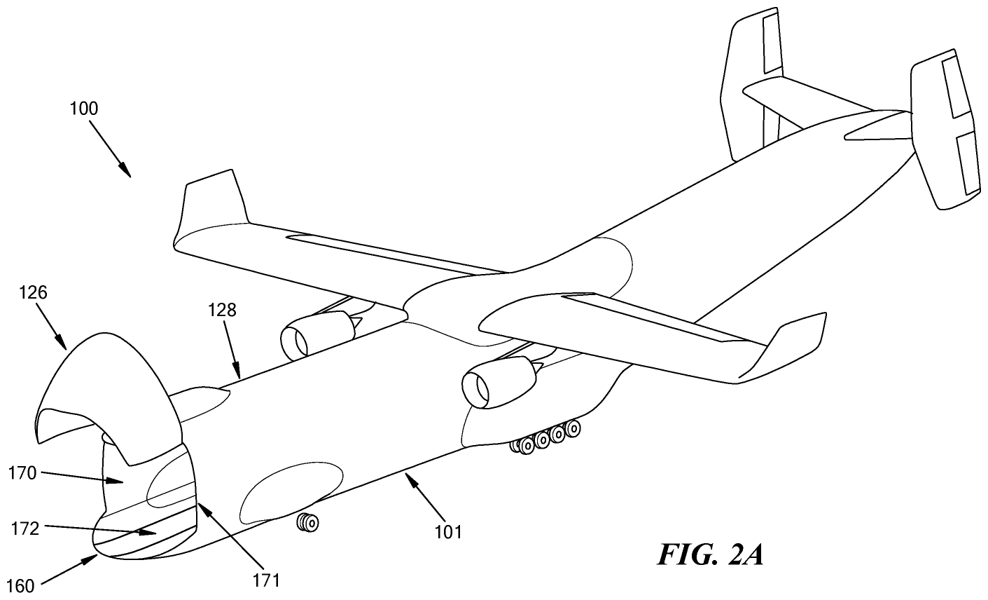

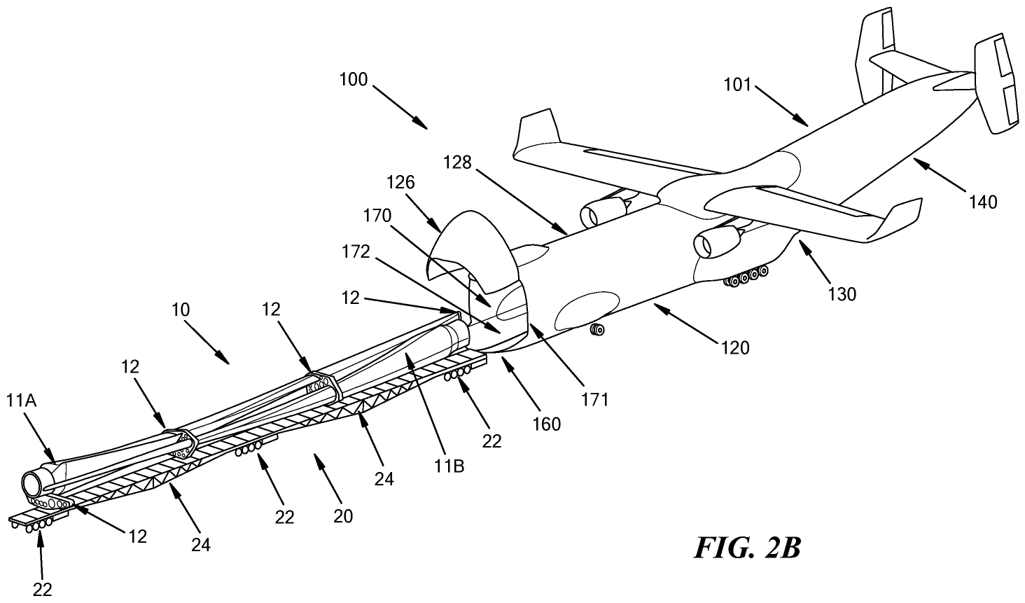

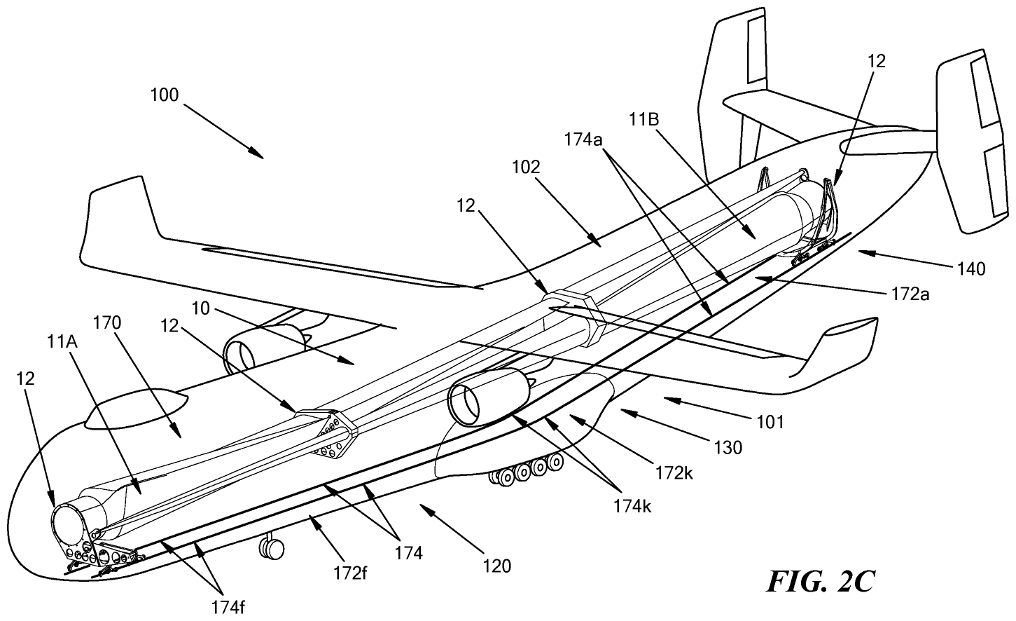

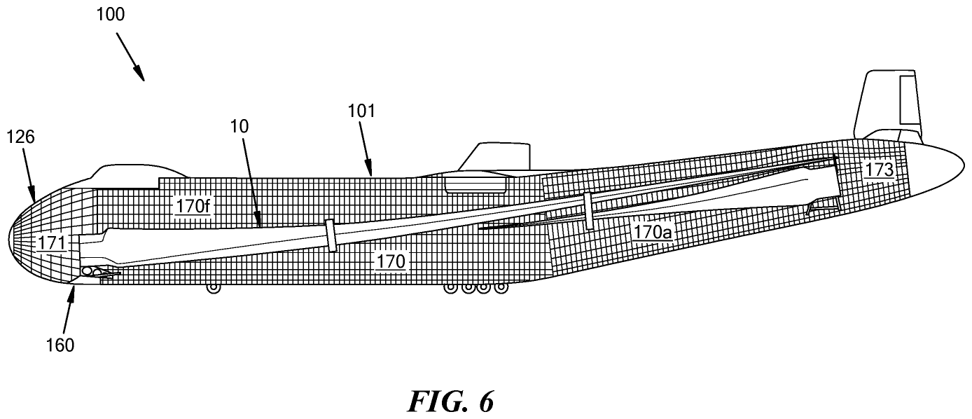

The focus of the present disclosures is described with respect to a large aircraft 100, such as an airplane, illustrated in FIGS. 1A and 1B, along with the loading of a large payload into the aircraft, illustrated at least in FIGS. 2A-2C and 6. In the illustrated embodiment, a payload 10 is a combination of two wind turbine blades 11A and 11B (FIGS. 2B and 2C), although a person skilled in the art will appreciate that other payloads are possible. Such payloads can include other numbers of wind turbine blades (e.g., one, three, four, etc., or segments of a single even larger blade), other components of wind turbines (e.g., tower segments, generator, hub, etc.), or other large structures and objects whether related to wind turbines or not. The present application can be used in conjunction with most any large payload-large for the present purposes being at least about 57 meters long, or at least about 60, 65, 75, 85, 90, 100, 110, or 120 meters long—or for smaller payloads if desired. Beyond wind turbines, the aircraft 100 can be used with most any size and shape payload, but has particular utility when it comes to large, often heavy and/or bulky and/or irregularly-shaped, payloads.

As shown, for example in FIGS. 1A, 1B, and 2A-2C, the aircraft 100, and thus its fuselage 101, includes a forward end 120 and an aft end 140, with a kinked portion 130 connecting the forward end 120 to the aft end 140. The forward end 120 is generally considered any portion of the aircraft 100, and related components, that are forward of the kinked portion 130 and the aft end 140 is considered any portion of the aircraft 100, and related components, that are aft of the kinked portion 130. The kinked portion 130 is a section of the aircraft 130 in which both a top-most outer surface 102 and a bottom-most outer surface 103 of the fuselage 101 become angled, as illustrated by an aft centerline CA of the aft end 140 of the fuselage 101 with respect to a forward centerline CF of the forward end 120 of the fuselage 101.

The forward end 120 can include a cockpit or flight deck 122, as shown located at a top portion of the aircraft, thus providing more space for cargo, and landing gears, as shown a forward or nose landing gear 123 and a rear or main landing gear 124. The forward-most end of the forward end 120 includes a nose cone 126. As illustrated more clearly in FIG. 2A, the nose cone 126 can be functional as a door, optionally referred to as the nose cone door, thus allowing access to an interior cargo bay 170 defined by the fuselage 101 via a cargo opening 171 exposed by moving the nose cone door 126 into an open or loading position as shown.

The interior cargo bay 170 is continuous throughout the length of the aircraft 101, i.e., it spans a majority of the length of the fuselage. The continuous length of the interior cargo bay 170 includes the space defined by the fuselage 101 in the forward end 120, the aft end 140, and the kinked portion 130 disposed therebetween. The interior cargo bay 170 can thus include the volume defined by nose cone 126 when closed, as well as the volume defined proximate to a fuselage tail cone 142 located at the aft end 140. The fixed portion 128 of the forwards fuselage 101 is the portion that is not the nose cone 126, and thus the forwards fuselage 101 is a combination of the fixed portion 128 and the nose cone 126. Alternatively, or additionally, the interior cargo bay 170 can be accessed through other means of access, including but not limited to a door located in the aft end 140.

One advantage provided by the illustrated configuration is that by not including an aft door, the interior cargo bay 170 can be continuous, making it significantly easier to stow cargo in the aft end 140 all the way into the fuselage tail cone 142. Existing large cargo aircraft are typically unable to add cargo in this way (e.g., upwards and aftwards) because any kink present in their aft fuselage is specifically to create more vertical space for an aft door to allow large cargo into the forwards portion of the aircraft.

A floor 172 can be located in the interior cargo bay 170, and can also extend in a continuous manner, much like the bay 170 itself, from the forward end 120, through the kinked portion 130, and into the aft end 140. The floor 172 can thus be configured to have a forward end 172f, a kinked portion 172k, and an aft end 172a. In some embodiments, the floor 172 can be configured in a manner akin to most floors of cargo bays known in the art. In some other embodiments, one or more rails can be disposed in the interior cargo bay 170 and can be used to assist in loading a payload, such as the payload 10, into the interior cargo bay 170 and/or used to help secure the location of a payload once it is desirably positioned within the interior cargo bay 170. In order for a cargo aircraft 100 to have as large of a cargo bay 170 as possible, the bottom contact surface 172 can be, effectively, the inner-facing side of the exterior skin of the fuselage. In such an arrangement, the bottom contact surface 172 is not designed to carry significant of the weight of the payload. Instead, rails can be structurally integrated with the fuselage 101 to carry the weight of the payload. A traditional cargo bay floor can be provided using a plurality of cargo bay floor segments that removably attach to the rails and can be advanced into the cargo bay 170 to form a continuous flat cargo bay floor.

Opening the nose cone 126 not only exposes the cargo opening 171 and the floor 172, but it also provides access from an outside environment to a cantilevered tongue 160 that extends from or otherwise defines a forward-most portion of the fixed portion 128 of the fuselage 101. The cantilevered tongue 160 can be used to support a payload, thus allowing the payload to extend into the volume of the interior cargo bay 170 defined by the nose cone 126.

A wingspan 180 can extend substantially laterally in both directions from the fuselage. The wingspan 180 includes both a first and second fixed wings 182, extending substantially perpendicular to the fuselage 101. In the illustrated embodiment, two engines 186, one mounted to each wing 182, 184, are provided, and other locations for engines are possible, such as being mounted to the fuselage 101.

The kinked portion 130 provides for an upward transition between the forward end 120 and the aft end 140. The kinked portion 130 includes a kink, i.e., a bend, in the fixed portion 128 of the fuselage 101 such that both the top-most outer surface 102 and the bottom-most outer surface 103 of the fuselage 101 become angled with respect to the centerline CF of the forward end 120 of the aircraft 100. Notably, although the present disclosure generally describes the portions associated with the aft end 140 as being “aft,” in some instances they may be referred to as part of a “kinked portion” or the like because the entirety of the aft end 140 is angled as a result of the kinked portion 130. Despite the angled nature of the aft end 140, the aircraft 100 is specifically designed in a manner that allows for the volume defined by the aft end 140, up to almost the very aft-most tip of the aft end 140, i.e., the fuselage tail cone 142, to receive cargo as part of the continuous interior cargo bay 170.

Proximate to the fuselage tail cone 142 can be an empennage 150, which can include horizontal stabilizers for providing longitudinal stability, elevators for controlling pitch, vertical stabilizers for providing lateral-directional stability, and rudders for controlling yaw, among other empennage components known to those skilled in the art.

The aircraft 100 is particularly well-suited for large payloads because of a variety of features, including its size. A length from the forward-most tip of the nose cone 126 to the aft-most tip of the fuselage tail cone 142 can be approximately in the range of about 60 meters to about 150 meters. Some non-limiting lengths of the aircraft 100 can include about 80 meters, about 84 meters, about 90 meters, about 95 meters, about 100 meters, about 105 meters, about 107 meters, about 110 meters, about 115 meters, or about 120 meters. Shorter and longer lengths are possible. A volume of the interior cargo bay 170, inclusive of the volume defined by the nose cone 126 and the volume defined in the fuselage tail cone 142, both of which can be used to stow cargo, can be approximately in the range of about 1200 cubic meters to about 12,000 cubic meters, the volume being dependent at least on the length of the aircraft 100 and an approximate diameter of the fuselage (which can change across the length). One non-limiting volume of the interior cargo bay 170 can be about 6850 cubic meters. Not accounting for the very terminal ends of the interior cargo bay 170 where diameters get smaller at the terminal ends of the fuselage 101, diameters across the length of the fuselage, as measured from an interior thereof (thus defining the volume of the cargo bay) can be approximately in the range of about 4.3 meters to about 13 meters, or approximately in the range of about 8 meters to about 11 meters. One non-limiting diameter of the fuselage 101 proximate to its midpoint can be about 9 meters. One non-limiting length of the wingspan 180 can be about 80 meters.

A person skilled in the art will recognize these sizes and dimensions are based on a variety of factors, and thus they are by no means limiting. Nevertheless, the large sizes that the present disclosure both provides the benefit of being able to transport large payloads, but faces challenges due, at least in part, to its size that make creating such a large aircraft challenging. The engineering involved is not merely making a plane larger. As a result, many innovations tied to the aircraft 100 provided for herein, and in other commonly-owned patent applications, are the result of very specific design solutions arrived at by way of engineering.

### Payload Loading, Unloading, and Stowing

FIGS. 2B and 2C provide for a general, simplified illustration of one exemplary embodiment of loading a large payload 10 into the aircraft 100. As shown, the cargo nose door 126 is open, exposing the interior cargo bay 170, which can extend through the kinked portion 130 and through essentially the entirety of the aft end 140. The cargo opening 171 provides access to the interior cargo bay 170, and the cantilevered tongue 160 can be used to help initially receive the payload. As shown, the payload 10 includes two wind turbine blades 11A, 11B, held with respect to each other by payload-receiving fixtures 12. The payload-receiving fixtures 12 are generally considered part of the payload, although in an alternative interpretation, the payload 10 can just be configured to be the blades 11A, 11B.

The payload 10, which can also be referred to as a package, particularly when multiple objects (e.g., more than one blade, a blade(s) and ballast(s)) are involved, possibly secured together and manipulated as a single unit, can be delivered to the aircraft 100 using most any suitable devices, systems, vehicles, or methods for transporting a large payload on the ground. A package can involve a single object though. In the illustrated embodiment, a transport vehicle 20 includes a plurality of wheeled mobile transporters 22 linked together by a plurality of spans, as shown trusses 24. Alternatively, or additionally, an outside mechanism can be used to move the vehicle 20, such as a large vehicle to push or pull the vehicle 20, or various mechanical systems that can be used to move large payloads, such as various combinations of winches, pulleys, cables, cranes, and/or power drive units.

As shown in FIG. 2B, the transport vehicle 20 can be driven or otherwise moved to the forward end 120 of the aircraft 100, proximate to the cargo opening 171. Subsequently, the payload 10 can begin to be moved from the transport vehicle 20 and into the interior cargo bay 170. This can likewise be done using various combinations of one or more winches, pulleys, cables, cranes, and/or power drive units, such set-ups and configurations being known to those skilled in the art. The system and/or methods used to move the payload 10 into the cargo bay 170 can continue to be employed to move the payload 10 into the fully loaded position illustrated in FIG. 2C. FIG. 2C is a perspective view of the cargo aircraft 100 of FIG. 1A showing a pair of rails 174 coupled to, extending from, or otherwise associated with the bottom contact surface 172 of the cargo bay 170 that extends along the cargo bay 170 from a forward entrance to and through the aft section of the cargo bay 170 in the aft portion 140 (not visible) of the fuselage 101. The rails 174 can thus be configured to have a forward end 174f, a kinked portion 174k, and an aft end 174a. In some embodiments, the rail(s) 174 can serve as a primary structural member(s) or beam(s) of the fuselage 101, capable of bearing operational flight and/or ground loads, akin to a keel beam in some aircraft.

Additional details about tooling for cargo management, including rails and payload-receiving fixtures and fuselage configuration for enabling loading and unloading of payloads into aft regions of a continuous interior cargo bay are provided in International Patent Application No. PCT/US2020/049784, entitled “SYSTEMS AND METHODS FOR LOADING AND UNLOADING A CARGO AIRCRAFT,” and filed Sep. 8, 2020, and the content of which is incorporated by reference herein in its entirety.

As a result of the unique nature of the kinked cargo bay configuration, new challenges arise when trying to load or unload large cargo into or out of the non-linear cargo bay. One solution involves systems and methods for loading and unloading the cargo along a curved path inside the fuselage. Examples include tooling and fixtures to enable moving a large cargo in a forward or aft direction while concurrently rotating the large cargo about a center point of an arc such that the large cargo moves along a curved or arc path in a forward or aft direction within the aircraft. Additional details are provided in International Patent Application No. PCT/US2021/21794, entitled “SYSTEMS AND METHODS FOR LOADING AND UNLOADING A CARGO AIRCRAFT UTILIZING A CURVED PATH,” and filed Mar. 10, 2021, and the content of which is incorporated by reference herein in its entirety.

### Kinked Fuselage

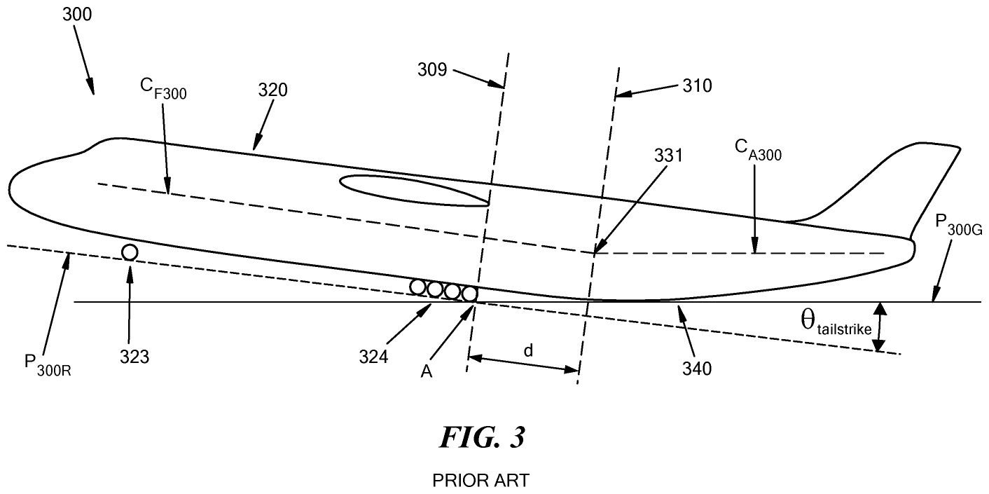

FIG. 3 is an illustration of a prior art aircraft 300 during a takeoff pitch-up maneuver showing the calculating of a tailstrike angle (θₜₐᵢₗₛₜᵣᵢₖₑ), which is determined when a forward end 320 of the aircraft 300 is lifted away from the ground P_{300G} (e.g., a runway of an airport) and an aft end 340 and tail of the aircraft 300 is pushed towards the ground 50 until contact. This change occurs during a takeoff pitch-up maneuver when the aircraft 300 pitches (e.g., rotates) about a lateral axis of rotation, indicated as “A” in FIG. 3. This lateral axis of rotation, A, is typically defined by the main landing gear 324, which acts as a pivot point to allow a downwards force generated by the tail to lift the forward end 320 of the aircraft 300. In FIG. 3, the nose landing gear 323 and main landing gear 324 define a resting plane P_{300R} (e.g., plane horizontal with the ground plane P_{300G} when the aircraft is resting), such that the tailstrike angle θₜₐᵢₗₛₜᵣᵢₖₑ can be defined by the change in the angle of the ground plane P_{300G} with respect to the resting plane P_{300R} when the aircraft 300 has achieved a maximal pitch angle or takeoff angle, which occurs just before any part of the aft end 340 of the aircraft 300 strikes the ground. In FIG. 3, a forward center line C_{F300} of the aircraft 300 is shown, along with an aft centerline C_{A300}. In order to increase θₜₐᵢₗₛₜᵣᵢₖₑ, larger aircraft 300 usually have an upsweep to the lower surface of an aft region of the aft fuselage. This upsweep deflects the centerline C_{A300} with respect to the forward center line C_{F300} at the initiation of the upsweep, which is shown in FIG. 3 as a bend 331 in the centerlines C_{F300}, C_{A300}. In prior art aircraft 300, this bend 331 occurs a certain distance, shown in FIG. 3 as distance “d” aft of the lateral axis of rotation A. Longer values of distance “d” increase the constant cross-section length of the aircraft 300. Aspects of the present disclosure eschew this prior art incentive for increasing distance “d” and instead significantly reconfigure the relationship between the aft fuselage and forward fuselage such that decreasing distance “d” can result in increasing the maximum usable cargo bay length.

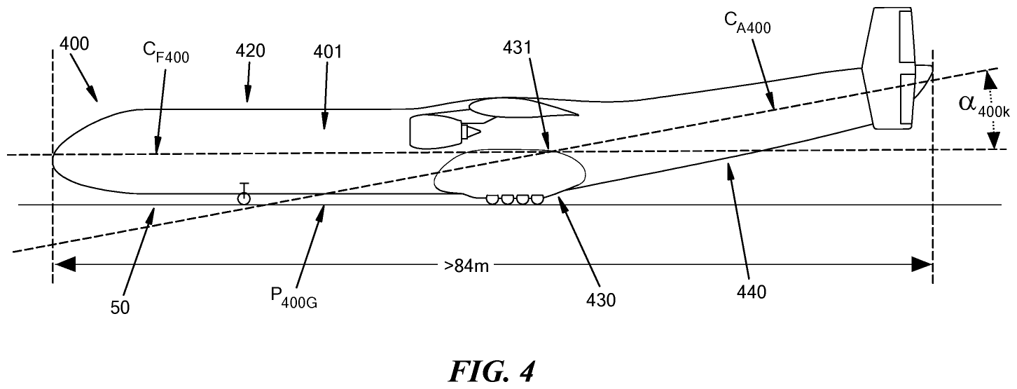

FIG. 4 is a side view illustration of an exemplary cargo aircraft 400 of the present disclosure. The aircraft 400, which is shown to be over 84 meters long, includes a fuselage 401 having a forward end 420 defining a forward centerline C_{F400} and an aft end 440 defining an aft centerline C_{A400}, with the aft centerline C_{A400} being angled up with respect to the forward centerline C_{F400}. The forward and aft centerlines C_{F400}, C_{A400} define a junction or kink 431 therebetween, where the forward centerline C_{F400} angles upward as the overall aft fuselage, which is in the aft end 440, changes in direction to be angled with respect to the forward fuselage, which is in the forward end 420. This defines a kink angle α_{400K} of the aft fuselage 440. The kink location 431 is contained in the kinked portion 430 disposed between and connecting the forward and aft ends 420, 440.

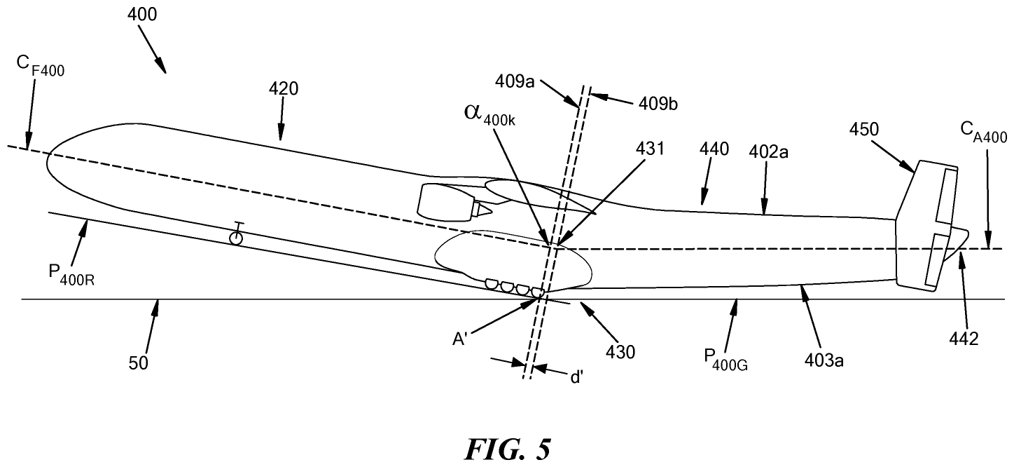

In FIG. 5, the angle of the aft centerline C_{A400} with respect to the forward centerline C_{F400} defines a kink or bend angle (illustrated as α_{400K} in FIG. 4), which can be approximately equal to an average of an angle of the after upper surface 402a and an angle of the lower surface 403a with respect to the forward centerline C_{F400}. Further, the kink angle α_{400K} can be approximately equal to a degree of maximal rotation of the aircraft during the takeoff operation. In FIG. 5, the cargo aircraft 400 is shown on the ground 50 and rotated about the lateral axis of rotation to illustrate, for example, a takeoff pitch-up maneuver. In FIG. 5, a resting plane P_{400R} of the forward end 420 angled with respect to the ground or ground plane P_{400G} at a degree just before θₜₐᵢₗₛₜᵣᵢₖₑ, as no part of the aft end 440, empennage 450, or tail 442 is contacting the ground. In this position, the lower surface 403a (and, approximately, the aft centerline C_{A400}) is substantially parallel with the ground or ground plane P_{400G}, and it can be seen that because the location of the centerline kink 431 of the kinked portion 430 is approximately with, or very close to, the lateral axis of rotation A′, the angle α_{400K} of the kink 431 is approximately the maximum safe angle of rotation of the aircraft 400 about the lateral axis of rotation A′.

FIG. 5 shows a vertical axis 409a aligned with the location of the lateral axis of rotation A′ and another vertical axis 409b aligned with the kink 431 in the fuselage centerline C_{F400}, with a distance d′ therebetween. With d′ being small, and the lower surface 403a of the aft end 440 extending aft with approximately the kink angle α_{400K} of the kink 431 or a slightly larger angle, as shown, the aft end 440 is highly elongated without risking a tail strike. Moreover, the upward sweep of the upper surface 402a can be arranged to maintain a relatively large cross-sectional area along most of the aft end 440, thereby enabling a substantial increase in the overall length of the cargo aircraft 400, and thus usable interior cargo bay within the aft end 440, without increasing θₜₐᵢₗₛₜᵣᵢₖₑ. Vertically aligning the kink location 131 with the lateral pitch axis can enable the aft fuselage 140 to extend without decreasing θₜₐᵢₗₛₜᵣᵢₖₑ, which also can enable the useable portion of the interior cargo bay 170 to extend aft along a substantial portion of the aft fuselage 140. The present designs also enable the creation of extremely long aircraft designs capable of executing takeoff and landing operations with shorter runway lengths than previously possible.

Examples of the aircraft 100 also include complex fuselage changes (e.g., the forward-to-aft kink or bend angle in the fuselage and interior cargo bay centerline) occurring over multiple transverse frames and longitudinally continuous skin panels, thus reducing the overall structural complexity of the transition zone. Additional details about kinked fuselages are provided in International Patent Application No. PCT/US21/21792, entitled “AIRCRAFT FUSELAGE CONFIGURATIONS FOR UPWARD DEFLECTION OF AFT FUSELAGE,” and filed Mar. 10, 2021, and the content of which is incorporated by reference herein in its entirety.

### Cargo Bay

FIG. 6 is side cross-section view of the cargo aircraft 100, the cross-section being taken along an approximate midline T-T of the top-most outer surface, as shown in FIG. 1A. The cargo bay 170 extends from a forward end 171 of a forward end or region 170f of the cargo bay 170, as shown located in the nose cone 126, to an aft end 173 of an aft end or region 170a of the cargo bay 170, as shown located in the fuselage tail cone 142. The forward and aft regions 170f, 170a of the cargo bay 170 sit within the forward and aft ends 120, 140, respectively, of the aircraft 100. FIG. 6 shows the aft region 170a of the cargo bay 170 extending through almost all of the aft fuselage 140, which is a distinct advantage of the configurations discussed herein. FIG. 6 shows a highly elongated payload 10 of two wind turbine blades 11A, 11B disposed substantially throughout the interior cargo bay 170 and extending from the forward end 171 of the forward region 170f to the aft end 173 of the aft region 170a.

FIG. 7 is a perspective view of the cargo aircraft 100 of FIG. 6 showing a lower support system 190A, 190B that extends along the cargo bay 170 from a forward entrance 171 to and through the aft section 170a (not visible) of the cargo bay 170 in the aft portion 140 (not visible) of the fuselage 101. The lower support system 190A, 190B can include forward portions 191A, 191B that extend forward along the cantilevered tongue 160 as well. In some examples, the lower support system 190A, 190B includes rails or tracks, or similar linear translation components, that enable a payload to be translated into the cargo bay 170 and all the way to the aft end of the aft region 170a of the cargo bay 170 from the cargo opening 171, for instance by having the lower support system 190A, 190B extend through nearly an entire length of the fixed portion 128 of the fuselage 101. In some examples, the lower support system 190A, 190B can be used to support and/or the payload during flight such that the lower support system 190A, 190B can hold substantially all of the weight of the payload.

Additional details about tooling for cargo management, including rails and payload-receiving fixtures and fuselage configuration for enabling loading and unloading of payloads into aft regions of a continuous interior cargo bay are provided in International Patent Application No. PCT/US2020/049784, entitled “SYSTEMS AND METHODS FOR LOADING AND UNLOADING A CARGO AIRCRAFT,” and filed Sep. 8, 2020, and the content of which is incorporated by reference herein in its entirety.

### Kinked Fuselage—Structural Details

In contrast to previous solutions that utilize a complex single wedge frame to connect two constant-section semi-monocoque fuselage structures together, and thereby drive all the complexity into that single wedge frame to keep complexity out of the two adjoining fuselage structures, examples of the present disclosure enable complex fuselage changes (e.g., the forward-to-aft kink or bend angle in the fuselage and interior cargo bay centerline) to over multiple transverse frames and longitudinally continuous skin panels. The examples of the present disclosure thus reduce the overall structural complexity transition zone between more simply shaped forward and aft fuselage sections.

Examples of the present disclosure provide for an entire semi-monocoque kinked transition section that can be constructed from multiple transverse frames, multiple skin panel segments, and stringers, with compound curvature skins to bridge the gap between two fuselage sections with different frame angles. Examples of the presently described transition section can be “plugged” in between forward and aft fuselage sections and can therefore be connected to a forward fuselage portion via a standard transverse frame (e.g., a ring frame that circumscribes the fuselage). Examples can likewise be connected to an aft fuselage portion via a different, but similarly standard, transverse frame oriented at an angle to accommodate the overall bend in the fuselage that occurs across the transition zone (i.e., the kinked portion of the fuselage that extends longitudinally between the transverse frame at the aft end of the forward portion and the transverse frame at the forward end of the aft portion), where most or all of the transverse frame sections of the forward portion are aligned in parallel and, similarly, most or all of the transverse frame sections of the aft portion are also aligned in parallel to each other and also at an angle (e.g., the bend angle) with respect to the transverse frame sections of the forward portion. However, examples of the present disclosure include transition sections that can be a unitary structure with forward and aft fuselage sections, such that the end frames of the forward and aft fuselage sections are also beginning frames of the transition section, or, alternatively one or more of the forward and aft fuselage sections and the transition section can be constructed as entire sub-segments that are joined together during a final assembly of the entire fuselage. The change in fuselage angle between the forward and aft transverse frames within the transition zone can occur over longitudinally continuous skin panels to reduce complexity of the angle change joint. In other words, aspects of the present disclosure can reduce the complexity of each single fuselage joint and frame compared with solutions where the fuselage bend occurs across any one single frame. Accordingly, examples of the present disclosure can instead add more complexity to the skin panels by extending the fuselage bend across two or more transverse frame sections, with curved, bent, and/or tapered longitudinal panels and/or frame stringers extending therebetween.

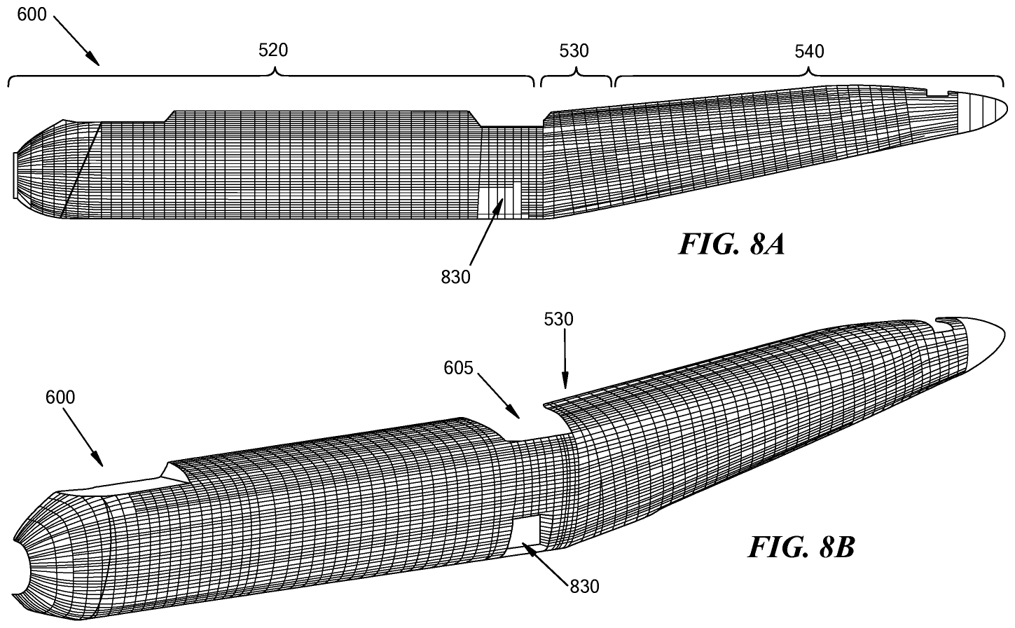

FIGS. 8A and 8B are 3D illustrations of the structural elements 600 of a cargo aircraft fuselage, showing the forward region 520, kinked transition region 530, and aft region 540, where the longitudinal structural members can be stringers and the transverse structural members can be transverse frame element (e.g., ring frames). FIG. 8B also shows that an upper wing cut-out 605 is formed in the aft end of the forward region 520 to permit the wing box to pass through the fuselage structure where it can be coupled to the structural elements 600 of a cargo aircraft fuselage. FIGS. 8A and 8B also illustrate a lower fuselage cutout 830 shaped to receive a floating landing gear assembly, as show in more detail in FIGS. 9A-14C, or a landing gear assembly having a drag brace, as shown in more details in FIGS. 15A-18B.

### Floating Main Landing Gear—Rocker Assembly Examples

FIGS. 9A-14C illustrate various embodiments of a floating main landing gear design that utilizes a rocker assembly (also referred to herein as a rocker torque box or a torque box) to support the main landing gear to the fuselage.

One example of an implementation of a floating main landing gear system is illustrated in FIG. 9A for an aircraft (e.g., aircraft 100 of FIG. 1A) having four main landing gear struts (e.g., two inner landing gear assemblies 925p, 925s and two outer landing gear assemblies 926p, 926s arranged in two main landing gear groups 124 each extending laterally from opposite sides of the fuselage 101) aligned side-by-side along a Y-oriented axis. Where the Y-axis is the lateral side-to-side direction of the fuselage. This arrangement improves load sharing between main landing gear (compared to tandem struts), takeoff rotation authority, and reduces wear on unpaved or semi-prepared runway surfaces by reducing main landing gear scrubbing during ground turning. However, due to a design intent to maximize available payload volume in the cargo bay, the landing gear groups 124 are pushed outboard laterally on each side far enough to avoid clashing with the payload keep-out volume (e.g., minimizing inward extension of the wheel well). As a result, an outboard-most landing gear strut centerline 912p, 912s on each side of the fuselage 101 is quite a bit farther outboard than the fuselage side-of-body 901f. Accordingly, the outer landing gear assemblies 912p, 912s are cantilevered off of the side 901f of fuselage body 101 by a non-trivial distance. Therefore, any vertical or longitudinal load on the outboard struts of the outer landing gear assemblies 912p, 912s result in a large moment about the X-axis (Mₓ) or Z-axis (M_{z}), respectively, where the primary airframe structures needs to react. Here, the X-axis is the longitudinal forward-to-aft direction of the fuselage 101 and the Z-axis is the vertical up-and-down direction. For example, in the case of the aircraft 100 of FIG. 1A, the landing gear struts can be as far as approximately 277 inches outboard of the aircraft centerline and the global moment about the X-axis (Mₓ) due to vertical loads on the landing gear assemblies can get quite large relatively (e.g., exceeding approximately 55 million in-lbs in the one gear landing load case—a load case in which all the vertical load from landing is concentrated on a single outboard most landing gear strut). However, and as shown in FIG. 9A, due to the lateral location of the two landing gear assemblies (e.g., inner and outer port landing gear assemblies 925p, 926p or inner and outer starboard landing gear assemblies 925s, 926s) strut centerlines on either side 901f of the fuselage 101 not being evenly spaced about the fuselage side of body 901f, even symmetric load cases (e.g., port and starboard main landing gear groups 124 reacting equal vertical forces) can result in a net Mₓ about a side 901f of the fuselage 101 where F_{z} is ideally reacted.

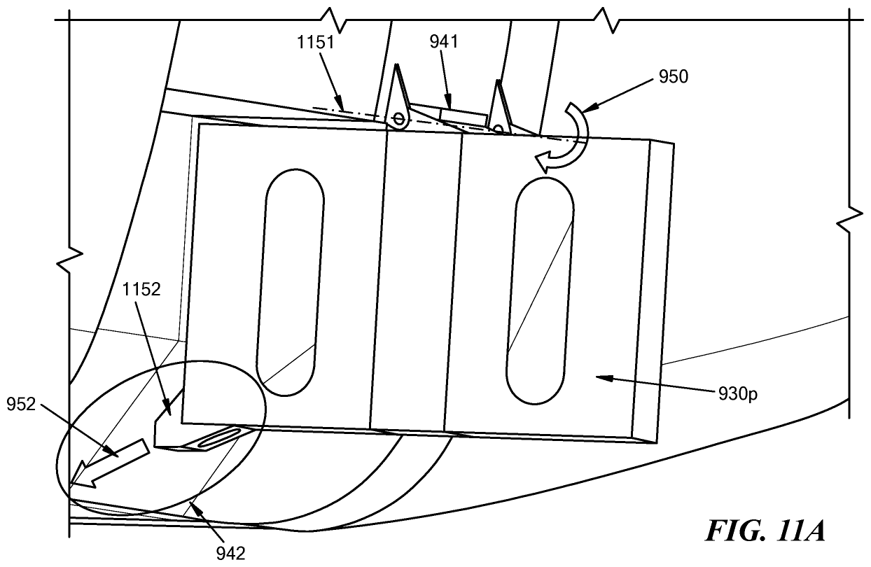

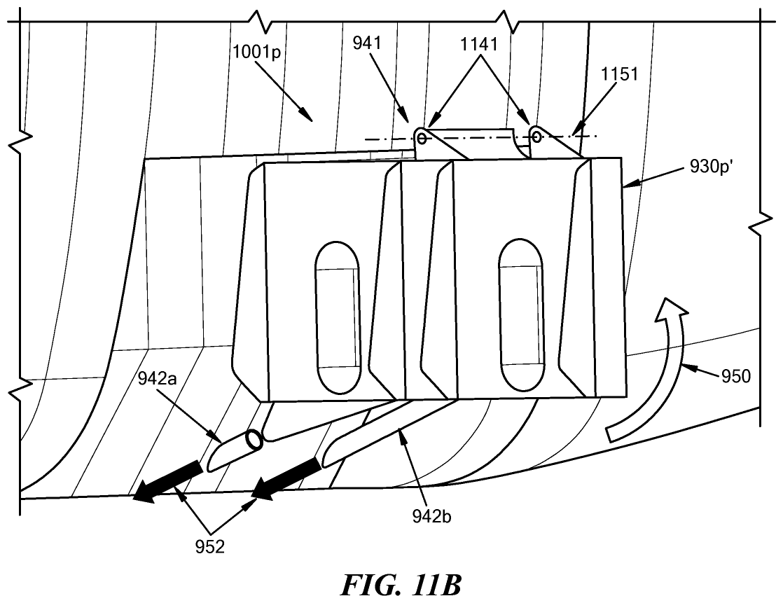

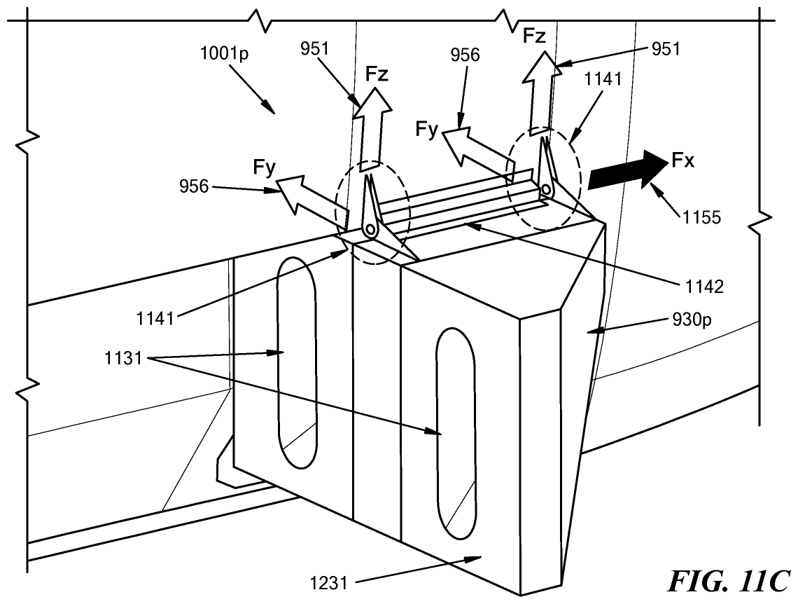

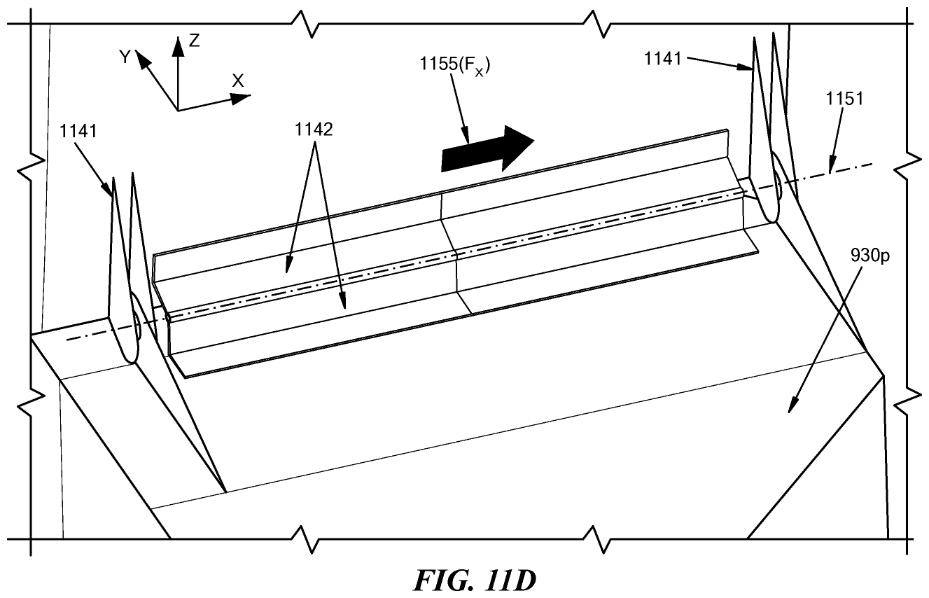

Other design constraints include fitting the landing gear assemblies 925, 926 and support structure (shown in more detail in FIGS. 11A-14C) that attaches the landing gear assemblies to the fuselage 101 inside of the sponson 901s, 901p contour. Often sponsons 901s, 901p are quite compact, especially in the vertical (Z) direction and do not allow much room around the landing gear assemblies because they are optimized for drag. Accordingly, if a more typical landing gear attachment design applied, instead of the floating landing gear examples presented herein, it would almost certainly require a larger size of the sponson 901s, 901p to have a reasonable angle back to the fuselage side of body frames and/or, as shown in FIG. 9B, compact sponson 901s, 901p designs do not leave much room to try and brace vertical loads with diagonal structural members 910x (which are drawn with Xs to indicate they are not structurally favorable as a replacement for the example floating landing gear systems of the present disclosure). Moreover, even if the sponson shape 901s, 901p was able to accommodate diagonal members 910x, lateral punch loads (F_{y}) and local moments (Mₓ) into the center fuselage side 901f are not desired (e.g., such loads would apply out of plane on the skin/stringers and drive center fuselage side 901f frames into bending). In addition to large global Mₓ loads, many load cases result in net Mₓ loads due to F_{z} imbalance between two gear struts on a single side. In addition to Mₓ, each MLG bogie is also capable of imparting net M_{y}, M_{z}, and all three force components into the fuselage 101.

In this section, moments are referred to as either global or local. In this context, global moments refer to moments that act on an entire assembly or system of assemblies based on applied external loads. Some examples of global moments would be a net Mₓ at a fuselage center line resulting from vertical load on all four main landing gear assemblies (as shown in FIG. 9A), or a net Mₓ on one side of the fuselage 101 resulting from vertical load on two landing gear assemblies on a single side of the fuselage 101. Another example would be a net M_{z} on one side of the fuselage 101 resulting from braking loads (e.g., longitudinal drag loads) on two main landing gear assemblies. A local moment refers to a moment at the fitting level or a single load introduction location, usually an internal load as a result of the connection type. An example of this would be the net moment at a fixed support on a cantilever beam.

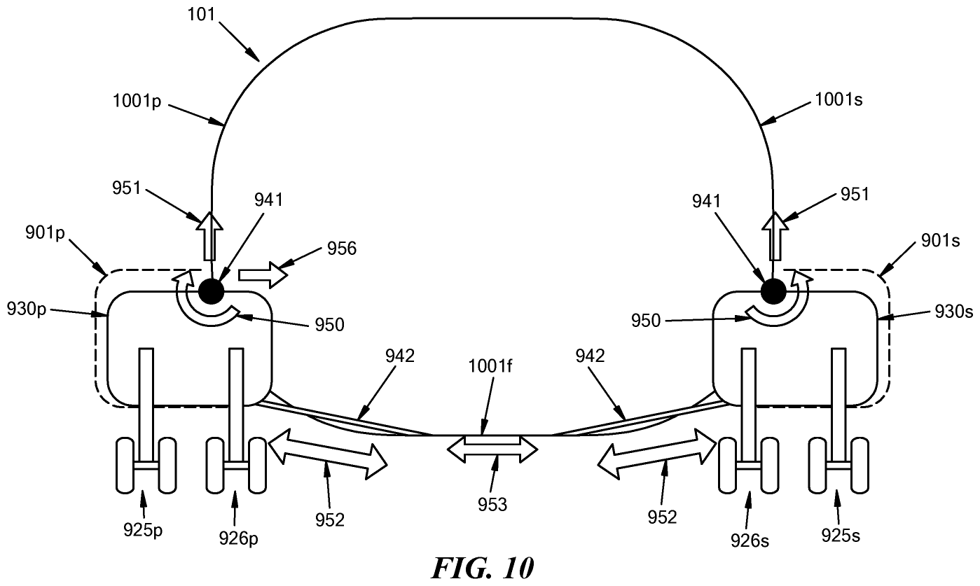

To efficiently react global Mₓ and M_{z} moments into the primary airframe structure while also staying inside the sponson contour, examples of the present floating main landing gear system can be utilized. A schematic example of the floating main landing gear system design is shown in FIG. 10 and more detailed implementations are illustrated in FIGS. 11A-14C. As discussed in more detail below, one of the advantages of examples of the floating main landing gear system is their ability to react global Mₓ moments as self-reacting lateral (Y-direction) tension loads through the fuselage floor. Due to the fuselage geometry, the floor can be much better equipped to handle lateral loads than the fuselage side of body higher up. The other advantage to this feature is the elimination of local moments at the fuselage side of body that would otherwise impart undesirable bending loads into the fuselage side of body frames.

The aircraft 100 of FIGS. 1A, 9A, and 9B is designed with side by side landing gear 124 configurations. Because other large airplanes are typically highly concerned with drag minimization, they squeeze the gears in closer to side of body (e.g., because other large airplanes are typically not as constrained on landing/takeoff performance on semi-prepared runways, they can position the gears in tandem and squeeze them closer to side of body). Or, if the gears are farther outboard relative to side of body, traditional aircraft main landing gear designs are attached to a wing structure, as most large commercial airplanes have a low wing configuration. As a result, a more typical landing gear support structure is integrated directly in with the fuselage side of body frames. The load path is approximately aligned with the frame beam axis direction and local bending loads on those frames are not a concern.

Examples of the present floating main landing gear system design shown in FIGS. 10-14C can include a rocker torque box 930p, 930s, two or more lug/clevis fittings 1141, one or more tie rod linkages 942, and a longitudinal strap fitting 1142. The torque box 930p, 930s can be one or more of a variety of structural elements, but generally represents a stiff volumetric hollow box or partially enclosed form that is sized and shaped to react both forces and moments about various attachment points. In the present examples, the torque box 930p, 930s is also configured to be the attachment point for one or more landing gear assemblies, which are assemblies configured to support the landing gear wheels below the aircraft and, in most instances, control the deployment and stowage of the landing gear assemblies inside the fuselage to reduce aerodynamic drag of the aircraft during flight. In some examples, at least a portion of the landing gear assemblies are able to be stowed within the torque box 930p, 930, with the torque box 930p, 930s itself being fully or partially surrounded by the main landing gear sponson secondary structure skin in a stowed configuration.

FIG. 10 is a cross-sectional view of an example floating landing gear system structurally coupling individual landing gear assemblies to the fuselage 101 inside the landing gear sponson of FIG. 9A. FIG. 10 shows port and starboard floating main landing gear systems that each include main landing gear group comprising an inner landing gear assembly 926p, 926s and an outer landing gear assembly 925p, 926s coupled to the fuselage 101 with a torque box 930p, 930s. Each torque box 930p, 930s is arranged inside a respective port or starboard sponson 901p, 901s and is coupled to the fuselage via an upper hinge 941 and lower static linkage 942. The upper hinge 941 permits rotation 950 of the torque box 930p, 930s about the hinge 941 and transfers vertical forces (as indicated by arrow 951), lateral forces (as indicated by arrow 956) and longitudinal forces (not indicated) into the lateral side 1001p, 1001s, of the fuselage 101 skin and/or transverse frame elements (as shown in FIGS. 8A and 8B). Each floating main landing gear system includes a lower static linkage 942 that connects a lower inboard corner or section of the torque box 930p, 930s to a lower 1001f section of the fuselage 1001 such that the rotation 950 of the torque box 930p, 930s is prevented by forces 952 transferred by the lower static linkage 942 between the torque box 930p, 930s and the lower 1001f section of the fuselage 1001. Together, both the port and starboard torque boxes 930p, 930s and their respective static linkages 942 direct forces to the lower 1001f section of the fuselage 1001 that are reacted 953 by the lower 1001f section of the fuselage 1001 between the connections to the static linkages 942. For example, a frame or other strengthening member can be disposed between the static linkages 942 at the lower fuselage section 1001f. In some examples, the static linkages 942 can be directly coupled to themselves or share a common connection point to the lower fuselage section 1001f.

One primary feature of the present examples of the floating main landing gear system is the ability to react global and local Mₓ loads through the fuselage floor 1001f instead of the side of body 1001p, 1001s. In a typical symmetric landing/ground load case where all landing gear assemblies 925p, 925s, 926p, 926s struts experience positive vertical (Z) loads, which are delivered to the torque box 930p, 930s, the net Mₓ about the hinge 941 (e.g., due to the lateral offset of the outside and inside landing gear assemblies 925p, 925s, 926p, 926s about the hinge 941) is self-reacted between port and starboard torque box 930p, 930s as a tension load through the static tie-rod linkages 942 into the fuselage floor skin panel 1001f and frames combo. Reacting Mx in this way eliminates the need for large diagonal (e.g., 910x of FIG. 9B) that would violate the sponson loft contour.

Referring now to FIGS. 11A to 11D, examples of the present floating main landing gear system are able to react large net Mₓ moments as lateral forces through the fuselage floor 1001f using a combination of pinned lug/clevis fittings 1141 and tie-rod linkages 942. The two or more lug/clevis fittings 1141 can utilize steel pins oriented along the longitudinal (e.g., X-axis) and are all aligned in tandem about the same X-oriented axis. The lug side of the fittings 1141 can be attached to the rocker torque box 930p, 930s while the clevis side can be attached directly to the fuselage side of body frames 1001p, 1001s (often two frames for each clevis). This allows the torque box 930s, 930p to pivot side to side about the X-oriented axis 1151 of the lug/clevis pins. The one or more tie-rod linkages 942 can be located on the bottom inboard corner of the rocker torque box 930p, 930s. The one or more tie-rod linkages 942 purpose is to resist the rocking motion 950 degree of freedom and balance out the net Mₓ moment. The tie-rod linkages 942 can be oriented with as shallow of an angle as possible from the fuselage flat floor panel 1001f, while still avoiding any clashing with landing gear components or necessary tire swap operational keep-outs. This shallow angle can result in most of the moment balance load going through the tie-rods 942 to be oriented laterally (e.g., stiffest load path through the floor panel 1001f).

Another advantage of some examples of the floating main landing gear system is that when all main landing gear struts (e.g., four, as illustrated in FIGS. 9A and 10) are under compression from a landing scenario, both port and starboard static linkages 942 on each side are pulling on the floor panel 1001f laterally in opposite directions. This efficiently self-reacts the net Mₓ as tension through the fuselage floor panel 1001f. Additionally, the hinge 941 can be implemented as a longitudinal strap fitting or a piano hinge to react longitudinal (X-direction) loads into the fuselage side of body 1001p coming from the landing gear assemblies 925p, 925s, 926p, 926s. The strap fitting can utilize a “C” shaped strap cross-section as to be very stiff in the longitudinal direction for preferentially reacting X-oriented loads, but very compliant in the Y and/or Z directions to minimally react lateral and/or vertical loads, which are instead reacted by two or more lug/clevis fittings 1141, as shown in more detail in FIG. 11D.

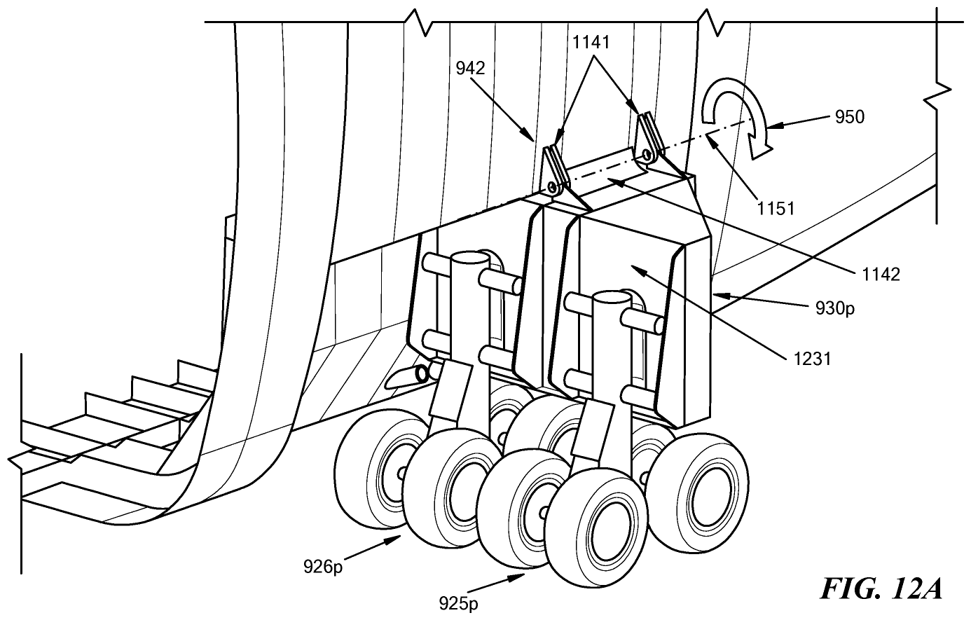

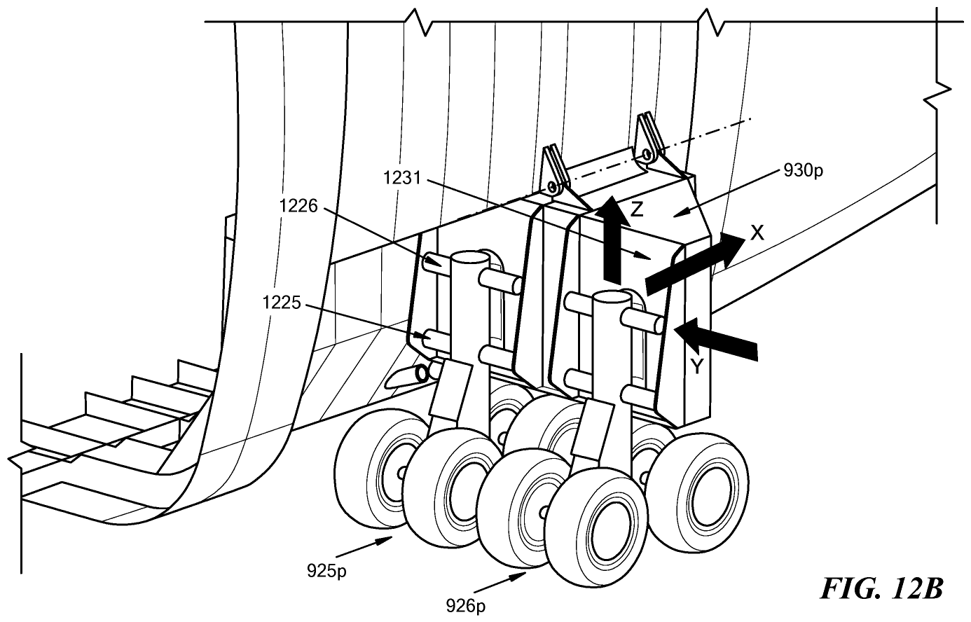

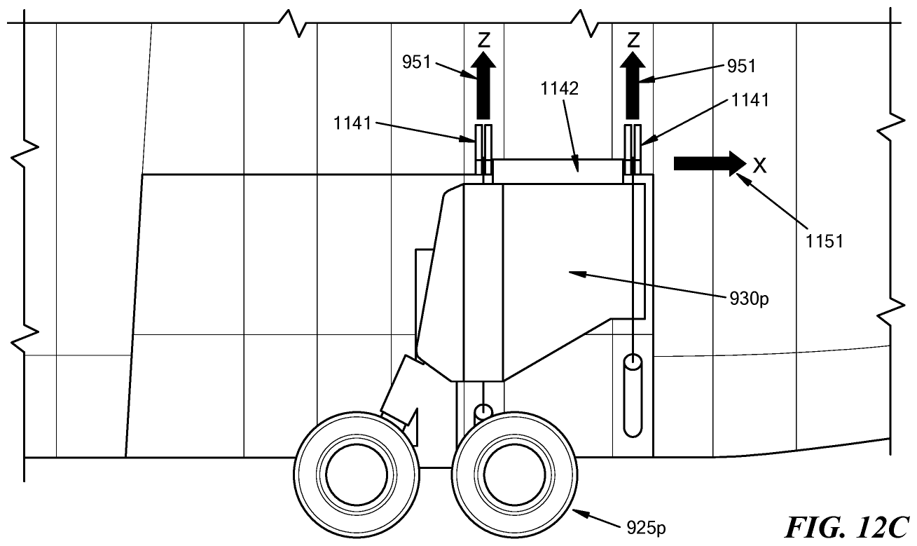

FIG. 11A is an isometric view of an example of a floating landing gear system of FIG. 10. The torque box 930p (also referred to herein as a rocker support structure) is used to channel global and local moments and force components efficiently from the landing gear assemblies 925p, 925s, 926p, 926s into the fuselage 101. The illustrated example floating landing gear system is comprised of five components: two X-pin lug/clevis fittings (e.g., components of the hinge 941 and shown more clearly in FIGS. 11C and 11D), the torque box 930p, 930s, a hinge fitting 941 (also shown more clearly in FIGS. 11C and 11D), and one or more tie-rod fittings (e.g., static linkages 942). In operation, the torque box 930p, 930s can be free to pivot about a single hinge line axis 1151 (e.g., substantially parallel to the X-axis and/or the side of the fuselage 1001p). That axis is a common rotational axis of the two X-pins lug/clevis fittings and the piano hinge (together the single axis hinge 941) except that rotation is prevented by the tie rod linkage 942, which can be connected to a coupler 1152 at a bottom inboard corner of the torque box 930p to constrain the rotational degree of freedom (e.g., rotation 950) through F_{y} and F_{z} force components that are delivered as the force vector 952 along the static linkage 942. The landing gear assemblies (not illustrated) can be directly attached to a front wall of the torque box 930p through, for example, a combination of pinned connections enabling Y-axis rotation at the gear trunnion and drag brace locations (e.g., drag brace pins 1226 in FIG. 12B).

FIG. 11B is an isometric view of another example of a floating landing gear system with a torque box 930p′ that is coupled to the fuselage with two static linkages 942a, 942b, each transferring a force 952 to the lower side of the fuselage 101.

FIG. 11C is an isometric view of the floating landing gear system of FIG. 11A with the forces transferred by the hinge assembly 941 to the side fuselage 1001p illustrated. The single-axis hinge assembly 941 includes a piano hinge 1142 and two lug/clevis fittings 1141 at opposite ends of the piano hinge 1142. The piano hinge joint 1142 can utilize two “L” shaped fittings (one on the fuselage side 1001p, one on the torque box 930p side) that connect at a hinge line 1151 concentric to pins of the two X-axis oriented lug/clevis fittings 1141. This arrangement enables the hinge assembly 941 to remain very stiff along the X-axis (e.g., shearing longitudinal X loads into the fuselage side of body 1001p over approximately 80 inches, as shown) while still allowing the torque box 930 to pivot about the two main lug/clevis pins 1141. The “L” shaped piano hinge 1142 fittings can be shaped purposefully as to remain soft in the Y and Z directions to direct those loads to the two lug/clevis fittings. As shown in FIG. 11C, the “L” shaped piano hinge 1142 fittings are configured to direct longitudinal forces (Fₓ, as indicated by arrow 1155) into the fuselage side 1001p. The two X-axis oriented lug/clevis fittings 1141 are each configured to direct lateral (F_{y}, as indicated by arrow 956) and vertical forces (F_{z}, as indicated by arrow 951). FIG. 11D shows the hinge assembly 941 in more detail, with the common axis 1151 of both the two X-axis oriented lug/clevis fittings 1141 and the piano hinge 1142 illustrated. FIG. 11C also shows the torque box 930p front wall 1231 includes cavities 1131 configured to receive structures and/or other structural members of the landing gear assemblies 925p, 925s, 926p, 926s to allow stowage of the landing gear assemblies 925p, 925s, 926p, 926s.

The forward and aft lug fittings 1141 can be either machined extensions of the rocker top wall or bolted directly to the torque box 930p top wall. Both the forward and aft clevis fittings 1141 can be bolted directly through the center fuselage 101 skin into the foot flanges of a pair of fuselage frames to support lateral (Y) out-of-plane loads. These forward and aft lug fittings 1141 will shear vertical (Z) loads into the fuselage 101 skin panel and frames. The forward and aft lug fittings 1141 together react lateral (M_{y}) and vertical (M_{z}) moments through vertical (F_{z}) and lateral (F_{y}) force couples, respectively.

Referring now to FIGS. 12A to 12C, FIG. 12A is an isometric view of the floating landing gear assembly of FIGS. 11A, 11C, and 11D with two sets of landing gear assemblies 925p, 925s, 926p, 926s to a front face 1231 torque box 930p, the front wall 1231 having the cavities 1131 configured to receive structures and/or other structural members of the landing gear assemblies 925p, 925s, 926p, 926s. FIG. 12B shows the forces and their location acted upon the front face 1231 of the torque box 930 by the landing gear assemblies 925p, 925s, 926p, 926s, and FIG. 12C shows the forces acting on the fuselage side of body 1001p by the torque box 930 with landing gear assemblies 925p, 925s, 926p, 926s attached. Each of the four landing gear assemblies 925p, 925s, 926p, 926s (e.g., two on each side of the fuselage 101) can have two Y-oriented trunnion pins 1225 and two Y-oriented drag brace pins 1226 (e.g., 4 pins per gear strut. The Y-oriented trunnion pins 1225 can react X, Y, and Z loads into the front wall 1231 and the Y-oriented drag brace pins 1226 can react X and Z loads into the front wall 1231. On both sides of the fuselage 101, two landing gear assemblies 925p, 925s, 926p, 926s are attached to the torque boxes 930p, 930s of floating main landing gear systems via the front-wall 1231 of the torque boxes 930p, 930s using their four trunnion pins 1225 and four drag brace pins 1226. The four drag brace pins 1226 can mount into lug fittings that are bolted to the torque box 930p, 930s front-wall 1231. The four trunnion pins 1225 can mount into trunnion support fittings also bolted to the torque box 930p, 930s front-wall 1231. As shown in FIG. 12B, the trunnion connections 1225 are configured to react global X, Y, and Z loads, and the drag brace connections 1226 are designed to only react global Z and X loads. Neither set of pins 1225, 1226 reacts local moments, as longitudinal (Mₓ) moments are reacted through a vertical (F_{z}) couple. Lateral (M_{y}) moments and vertical (M_{z}) moments are reacted through a longitudinal (Fₓ) couple. For example, in a symmetric landing (both main landing gear assemblies contact the ground simultaneously) longitudinal (Fₓ) forces, global longitudinal (Mₓ) moments, and global vertical (M_{z}) moments are reacted into the aircraft fuselage through the following reactions. For longitudinal forces (Fₓ) 1155, the piano hinge 1142 is the primary load path. For global longitudinal (Mₓ) moments, the floor beam 1001f self-reacts tension loads from the tie-rod linkages 942a, 942b. For global vertical (M_{z}) moments, both couple longitudinal (F_{y}) forces 956 at lug/clevis fittings 1141 and couple lateral (F_{y}) forces 1151 at the tie-rod linkages 942a, 942b.

Another example is observed during a typical aircraft braking operation. A longitudinal (Fₓ) force is generated between the tires and ground due to friction. This longitudinal (Fₓ) force results into a global lateral (M_{y}) moment between the gear assembly 925p, 925s, 926p, 926s and torque box 930 due to the vertical distance between the force application point at the ground/tire contact plane and the trunnion and drag brace interface 1226 locations on the landing gear 925p, 925s, 926p, 926s. The lateral (M_{y}) moment is reacted by the torque box 930 as a longitudinal force (Fₓ) couple between the trunnion interface (1225) and drag brace interface (1226) locations of the landing gear 925p, 925s, 926p, 926s. In turn the torque box 930 is able to react the net lateral moment (M_{y}) into the fuselage as a vertical force (F_{z}) couple 951 between the forward and aft lug/clevis fittings 1141.

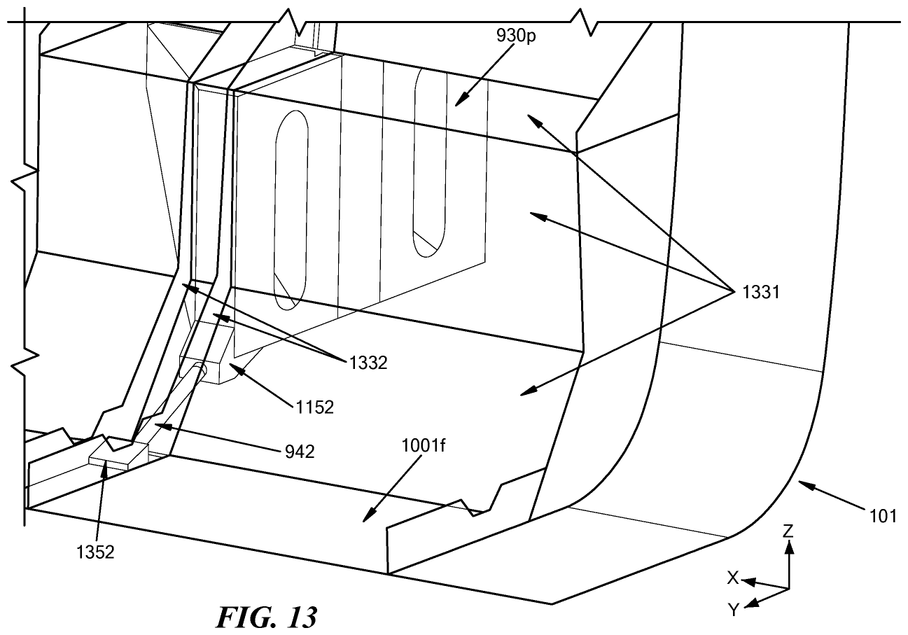

FIG. 13 is an isometric view of a tie-rod 942 connection between the lower fuselage 1001f and the coupler 1152 of the rocker torque box 930p of FIG. 11A. FIG. 13 is a semi-transparent view from inside the cargo bay 170 of the fuselage 101 of the aircraft 100 of FIGS. 1A and 9A. The fuselage, as mentioned above in FIGS. 8A and 8B, includes a wheel well 830 that extends into the cargo bay 170. The wheel well 830 is formed as a plurality of panels 1331 that provide space for the inboard end of the torque box 930p as well as the inboard landing gear assembly 925p, 925s. In addition to the skin panels of the fuselage 101 forming the wheel well, some of the transverse frame elements 1332 of the fuselage 101 are also formed to the shape of the wheel well 830. In FIG. 13, two transverse frame elements 1332 are connected with a lower support element 1352 that is structurally coupled with the static linkage 942 that connects the coupler 1152 of the torque box 930p to the lower side 1001f of the fuselage 101. Other fuselage connection arrangements are possible, such as a plurality of frames, one frame, and/or transverse structural elements to react forces from tie-rod fitting.

Each floating main landing gear system can utilize one or more tie-rod linkages 942 oriented mostly in the lateral (e.g., Y) direction, with a small Z-direction component, to react net Mₓ and lateral loads. This tie-rod linkage 942 can attach to the lower inner corner (e.g., connector 1152) of the rocker torque box 930p via a spherical pinned connection. The tie-rod linkage 942 can then pass through a cut-out located on the inner main landing gear wheel well 830 wall 1331 to attach to a fitting (e.g., lower support element 1352) located on the fuselage belly panel 1001f via a spherical pinned connection, as shown in FIG. 13. This lower support element 1352 is capable of shearing lateral loads into two adjacent fuselage frames 1332 and fuselage skin. The smaller vertical (Z) load components are reacted via bending through the two adjacent fuselage frames 1332. This arrangement enables the static linkage 942 to direct forces from the torque box 930p directly into the transverse frame elements 1332 and at an advantageous angle (e.g., a shallow angle between the static linkage 942 and the lower side 1001f of the fuselage in order to primarily load the transverse frame elements 1332 along their length (e.g., horizontally at the lower side 1001f of the fuselage 101).

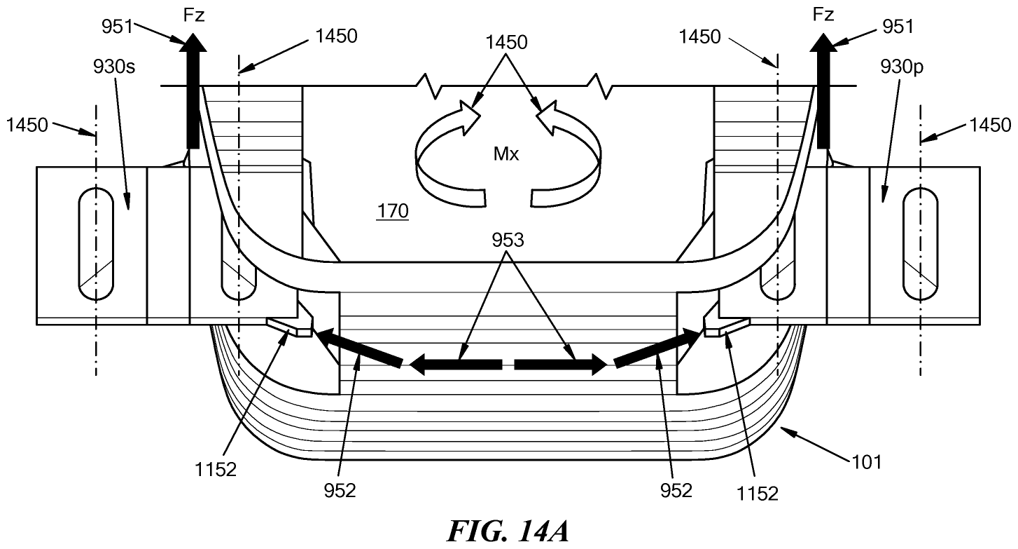

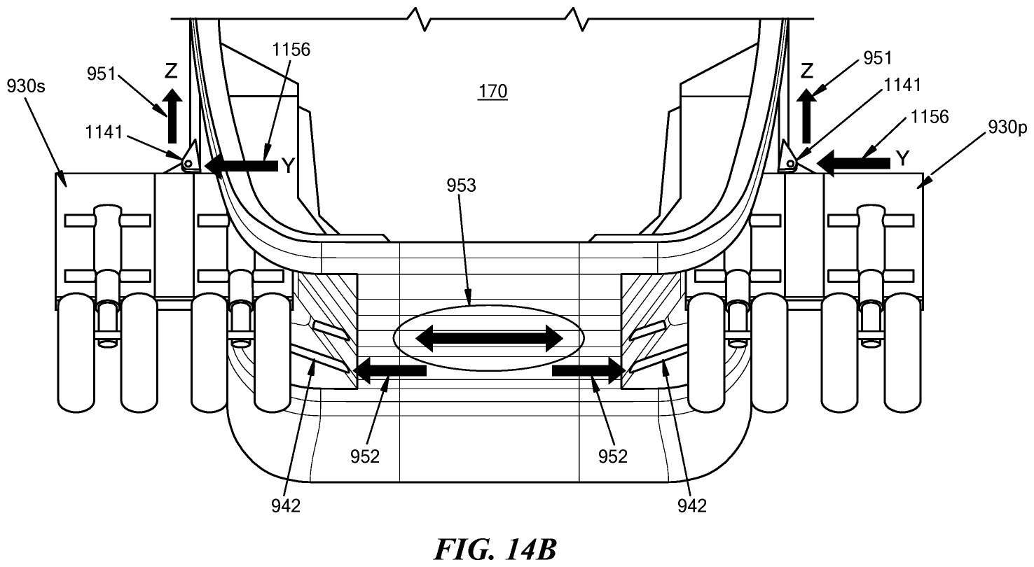

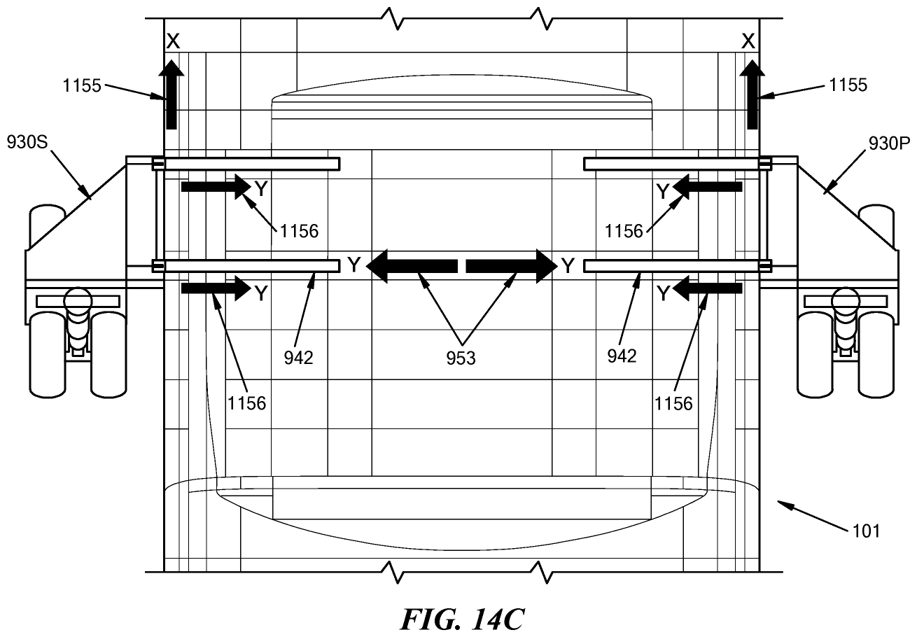

FIGS. 14A to 14C illustrate the aircraft 100 of FIGS. 1A and 9 with port and starboard floating main landing gear systems. FIG. 14A is a cross section view without individual landing gear assemblies and showing the major forces applied to the fuselage 101 by the rocker torque boxes 930p, 930s during a landing operation. Each landing gear assembly 925p, 925s, 926p, 926s (not shown in FIG. 14A) directs vertical forces 951 into each torque box 930p, 930s as indicated by lines 1450. Together, these vertical forces act about the center of the aircraft fuselage 101 to generate a net bending moment Mₓ 1450, with the individual torque boxes 930p, 930s also generating local moments about their hinges 941 that are reacted by the couplers 1152 and directed via forces 952 on static linkages (shown, for example, as static linkages 942 in FIGS. 10 and 11A) that are reacted at the lower side of the fuselage (e.g., forces 953 that pull in opposite directions at the center of the lower fuselage). FIG. 14B is a front view of the aircraft showing the lateral forces 1156 imparted by the lug/clevis fittings 1141 on the side of the fuselage 101. FIG. 14C is a top-down view of the aircraft showing the longitudinal forces 1155 imparted by the piano hinges 1142 on the side of the fuselage 101, as well as the lateral forces 1156 imparted by the lug/clevis fittings on the side of the fuselage 101, which are reacted to the center of the lower fuselage via linkages as forces 953 along the skin and/or frames of the lower section of the fuselage 101.

### Floating Main Landing Gear—Drag Brace Examples

FIGS. 15A-18C illustrate various embodiments of a second main landing gear design that utilizes a drag brace assembly (also referred to herein as drag strut or drag linkage) to transfer outboard longitudinal forces on the main landing gear (e.g., from wheel braking during a landing operation) to the fuselage while simultaneously contributing to reaction of moments about the Z-axis. In this manner, examples of the present disclosure include landing gear systems that utilize lateral and forward or aft drag braces to reduce or eliminate the transfer of vertical moments (e.g., M_{z}) to upper hinged connections between the landing gear assembly and the aircraft fuselage during expected aircraft takeoff and landing operations. Compared to a more typical landing gear attachment design, aspects of the present disclosure can utilize the additional rotational (in the vertical axis) stability to extend the position of the main landing gear outboard and/or extend the width of the landing gear assembly to position the outboard most wheel further away from the fuselage without inducing undesirably large moments on the landing gear's main vertical support elements (i.e., because the drag brace braces the outboard location of the landing gear system and can separately react those loads as tension or compression into the fuselage belly, instead of them being reacted as moments through vertical support elements). Also, reacting drag forces higher up (e.g., using vertical support elements) can put loads on the fuselage skin and/or frames that are normal to them, which is undesirable. Advantageously, the use of an outboard drag brace can significantly reduce forces due to moments about the Z-axis seen by the other support elements of the landing gear assembly, enabling those elements to be designed more efficiently, such as to be lighter and/or more articulatable (e.g., by reducing the rotational load requirements on joints and couplings).

One example of an implementation of a main landing gear system with a drag brace for an aircraft (e.g., aircraft 100 of FIG. 1A) is illustrated in FIGS. 15A-15C. FIG. 15A is an outboard isometric view of an aircraft landing gear system 1500 having a drag brace 1590, forward and aft lateral braces 1541, 1542, and a support assembly 1510. The support assembly carries four dual-wheel landing gears arranged in a dual twin tandem configuration, with a forward bank 1503 and an aft bank 1504 each including an inboard dual landing gear 1501 and an outboard dual landing gear 1502. The support assembly includes a forward primary upper support member 1511 and an aft primary upper support member 1512, each primary upper support member 1511, 1512 arranged to react vertical loads from a respective forward and aft bank 1503, 1504 of inboard and outboard dual landing gears 1501, 1502. The support assembly further includes a forward articulating lower support member 1521 and an aft articulating lower support member 1522. Each of the articulating lower support members 1521, 1522 is directly carrying the individual inboard and outboard dual landing gears 1501, 1502. Further, each articulates with a respective primary upper support member 1511, 1512 such that movement of the lower support members 1521, 1522 with respect to the respective primary upper support member 1511, 1512 can be: (i) resisted or damped by shock absorbers 1569; and/or (ii) controlled to move the landing gear between a deployed and a stowed configuration. The support assembly further includes a forward secondary upper support member 1531 and an aft secondary upper support member 1532. Each support member 1531, 1532 is arranged to support the upper attachment of the shock absorbers 1569 connection to the articulating lower support members 1521, 1522 and separately couple with a respective primary upper support member 1511, 1512. Secondary upper supports 1531, 1532 can be fixed pieces of structure disposed at an angle, as shown. The exact angle is not typically critical, however some amount of angle less than approximately 90 degrees (typically approximately in the range of about 45 degrees to about 75 degrees) with respect to horizontal (e.g., with respect to ground) provides a more efficient Fₓ load path at the upper pinned connections, which can be coupled with the primary Fₓ path lower down along the drag brace 1590 and lateral braces 1541, 1542 to provide a net M_{y} reaction as couple Fₓ. Secondary upper supports 1531, 1532 provide the load path from the shock absorbers 1569 to the fuselage side of body. Shock absorber loads can be oriented along the axis of the shock absorber. Additionally, the secondary upper supports 1531, 1532 can be attached to the landing retract mechanism that is positioned between the upper end of the shock absorbers and 1531, 1532. By articulating the retract mechanism about a Y-axis, the landing gear can be raised (for flight) and lowered (for landing). Another function of upper supports 1531, 1532 is to provide an upper hinged connection that does not resist lateral (M_{y}) moments, and provides a secondary longitudinal force (Fx) reaction in additional to the lateral braces 1541, 1542 and drag brace 1590 to handle longitudinal loads from the shock absorbers 1569. However, the primary lateral (Fₓ) load path is through the drag brace 1590 and the lateral braces 1541, 1542, which have a smaller vertical offset from the tire contact points with the ground.

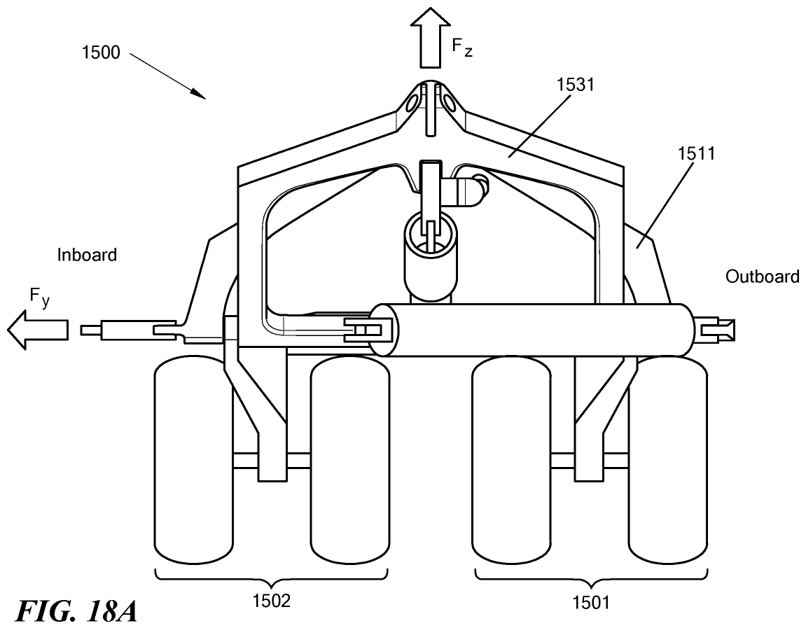

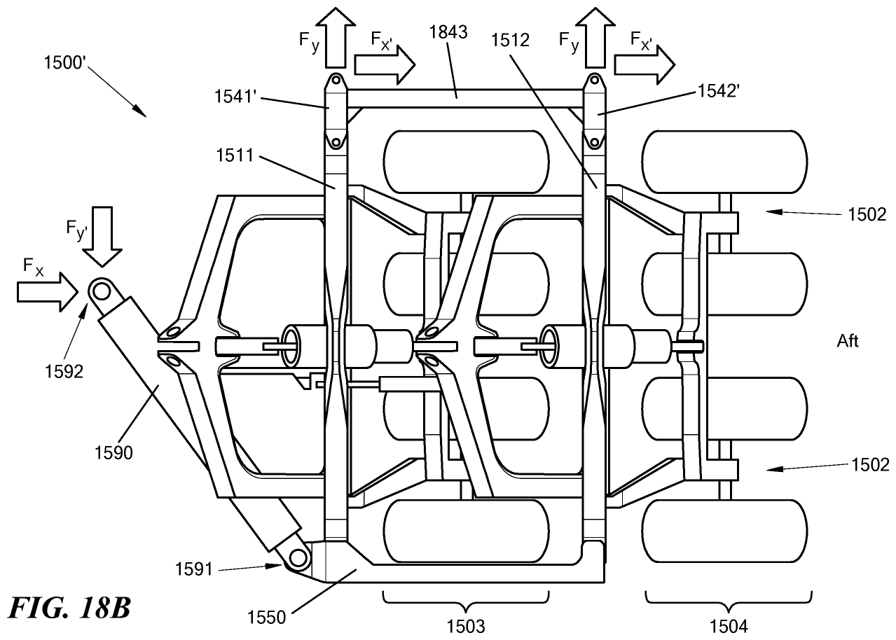

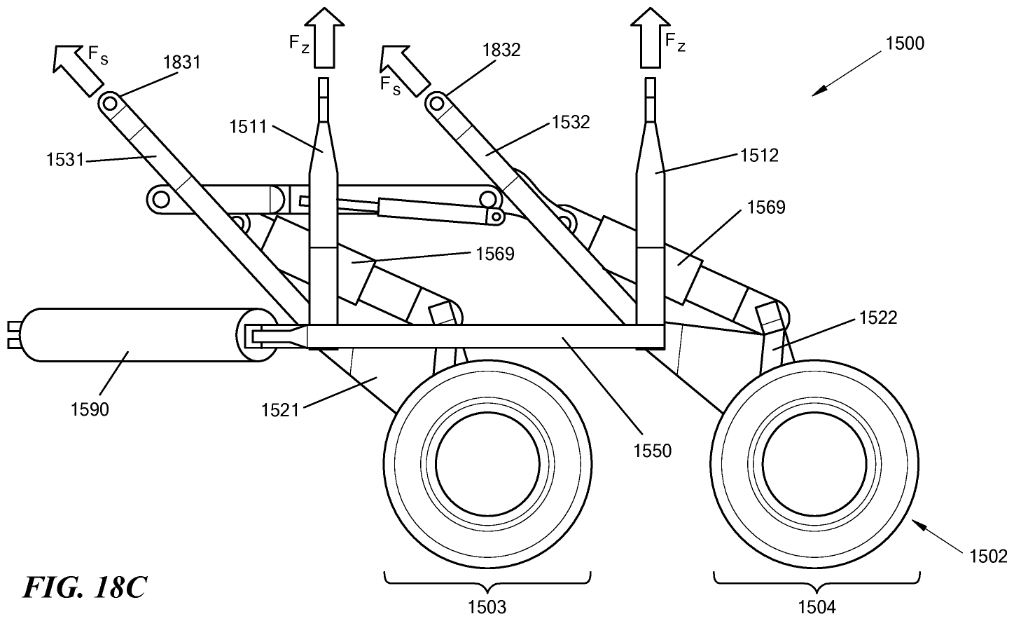

The primary upper support members 1511, 1512 can include upper hinged locations 1519 to allow rotation of the entire support assembly about a forward-aft axis, which prevents moments about this forward-aft axis (e.g., Mₓ) from being reacted locally to the fuselage (e.g., fuselage 101 in FIG. 1A), while still allowing vertical forces (e.g., Fz) and horizontal forces (e.g. F_{y}) to be reacted to the fuselage. Therefore, to stabilize the landing gear system 1500 about the forward-aft axis, forward and aft lateral braces 1541, 1542 can couple the support assembly to the fuselage and resist rotation of the support assembly about the upper hinged locations 1519. The forward and aft lateral braces 1541, 1542 are illustrated as linkages that, together, react lateral (F_{y}) and longitudinal (Fₓ) forces between the landing gear system and the fuselage. Accordingly, and as shown in more detail in FIG. 18B, the lateral braces can have other structural arrangements, such as a singular brace that is pinned to the fuselage in two places. The vertical location of the lateral braces 1541, 1542 being close to the landing gear wheel axles minimizes the lateral forces (F_{y}) that needed to be handled by any component of the support assembly.

The remaining primary force experienced by the landing gear is drag, which is often caused by wheel braking and tire spin-up/spring back during landing but can also be caused by inconsistency in the ground traveled by the landing gear. When any asymmetries in drag forces between the inboard and outboard landing gears arise, the drag forces can induce moments about the vertical axis (e.g., M_{z}). Although lateral braces 1541, 1542 can react vertical moments (M_{z}) via reacting lateral (F_{y}) forces, the lateral braces 1541, 1542 are unable to react all of the drag load directly due to their orientation and inboard position. Accordingly, a primary advantage of the drag brace is now observed: the drag brace 1590 is coupled with the outboard side of the support assembly and extends forwards to couple with the fuselage. In this configuration, longitudinal movement of the outboard side of the support assembly is also prevented, effectively decoupling the upper hinged locations of the primary upper support members 1511, 1512 from reacting vertical (yaw) moments (M_{z}). Instead, yaw moments can be more efficiently reacted as a longitudinal forces (Fₓ) between the outboard spanning braces 1550/1590 and inboard fittings 1541/1542. The drag brace 1590 thereby enables the outboard landing gear 1502 to be moved further outboard from the fuselage with respect to an upper connection of the landing gear assembly such that, in some examples, the upper hinged connection(s) experience zero net vertical (M_{z}) moment.

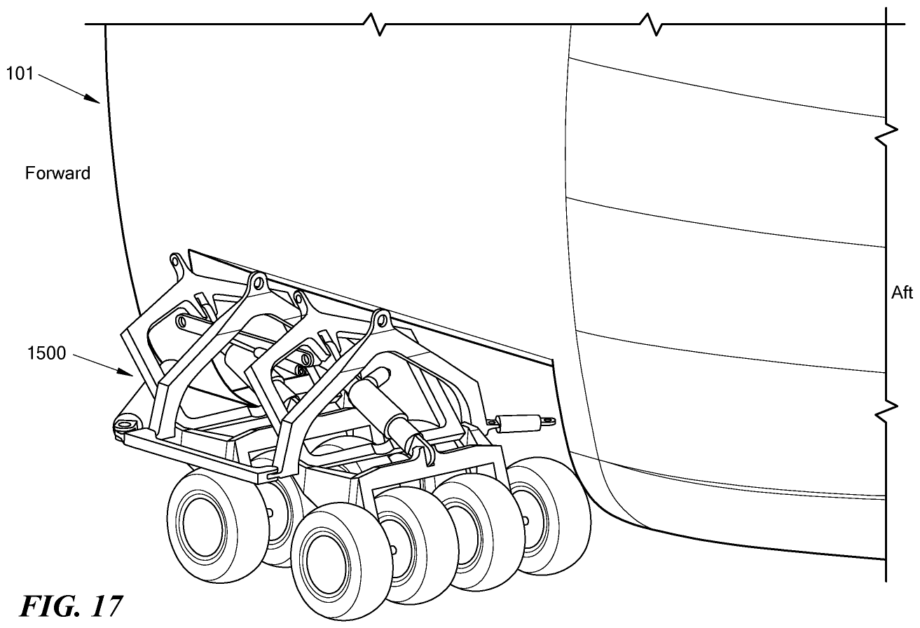

In the landing gear assembly 1500 of FIG. 15A, the drag brace 1590 connects to the outboard end of the forward upper and lower supports 1511, 1531, 1521 and an outboard spanning brace 1550 (also referred to herein as a longitudinal support element) couples the drag brace 1590 to the outboard end of the aft upper and lower supports 1512, 1532, 1522, thereby enabling the drag brace to, in combination with the lateral braces 1541, 1542, react vertical moments (M_{z}) from the entire support assembly as longitudinal and lateral forces into the fuselage. Moreover, one advantage of the drag brace examples of the present disclosure is that, by reacting lateral loads lower down into the fuselage near the belly, the longitudinal (Mₓ) moments resulting from lateral (F_{y}) punch forces are much more manageable. FIG. 17 illustrates the landing gear assembly 1500 positioned in a main landing gear cutout of an aircraft fuselage 101 (e.g., lower fuselage cutout 830 in FIGS. 8A and 8B) and FIGS. 18A-18C, discussed in more detail below, illustrate the forces reacted to the fuselage by the landing gear system 1500 in a landing operation of an aircraft.

The primary upper support members 1511, 1512, the secondary upper support members 1531, 1532, and the lower support members 1521, 1522 can be collectively referred to as lateral supports or lateral support members because they each support, in their respective ways, both inboard and outboard landing gears (e.g., these elements each extend laterally from an inboard location to outboard location in order to support both inboard and outboard landing gear). For example, the respective forward and aft inboard and outboard landing gears are separately carried by each lower support member 1521, 1522, which causes any asymmetries in the forces on the inboard and outboard landing gears to generate moments on the respective lower support member 1521, 1522. To reduce concentrating the generated moments at a central support location, each lower support member 1521, 1522 couples with a respective primary and secondary upper support member 1511, 1512, 1531, 1532 at two locations spaced apart laterally (e.g., an inboard and outboard location).

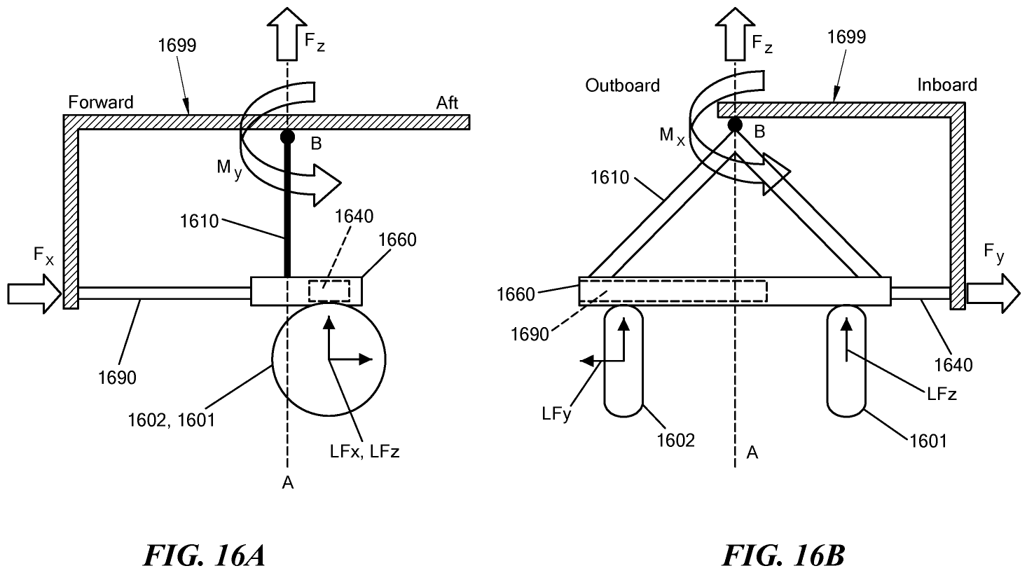

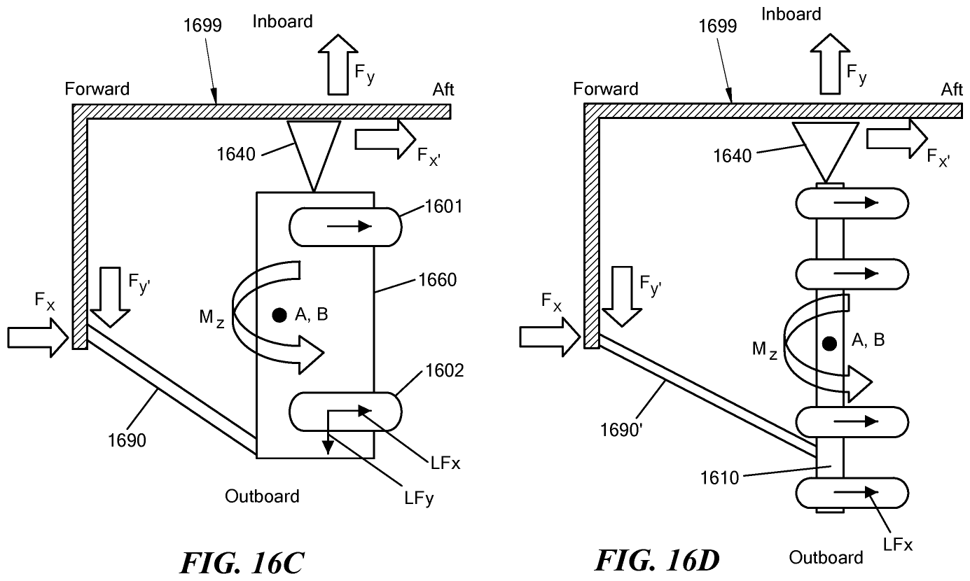

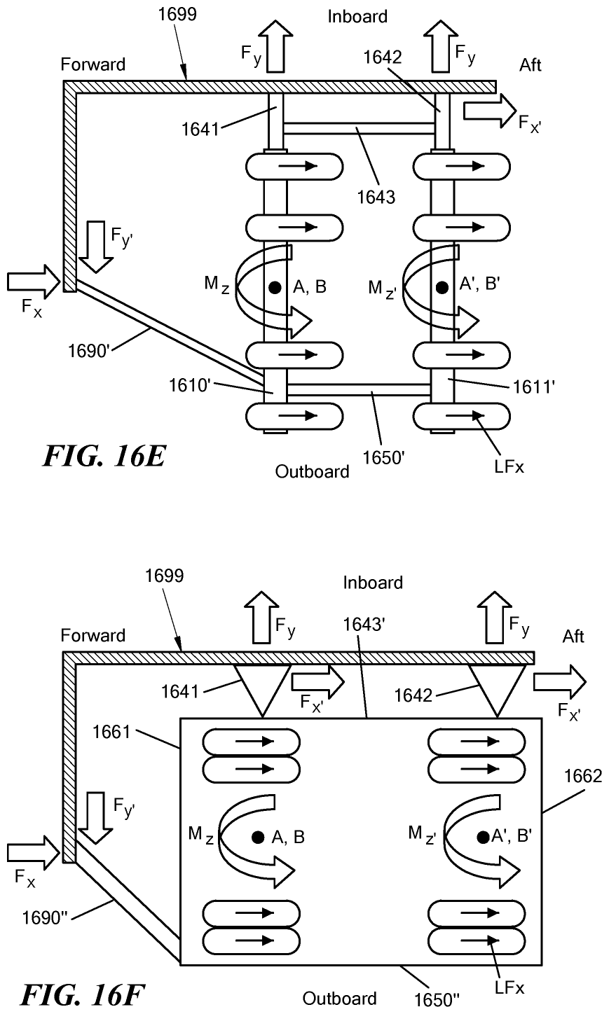

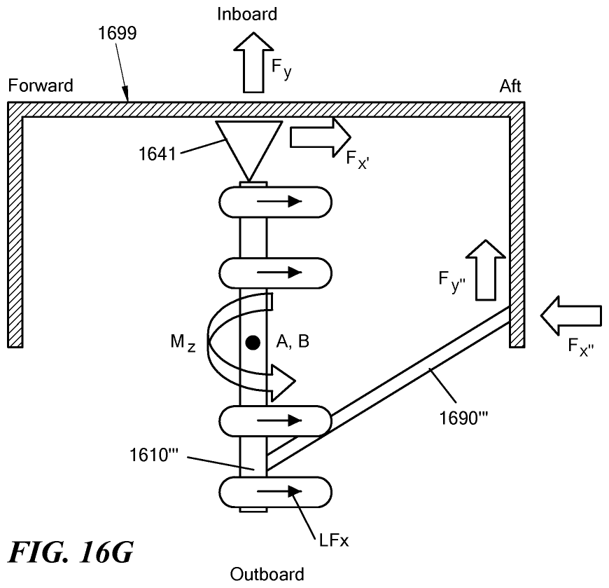

While the example of FIGS. 15A-15C, 17, and 18A-18C illustrate a representative implementation of a landing gear system including a drag brace, other arrangements are within the scope of the present disclosure, such as a drag brace that extends aftward, a drag brace that couples with the support assembly at an outboard location, but not necessarily at the outboard end of a lateral support element. FIGS. 16A-G illustrates these and other example implementations of a drag brace.

FIGS. 16A-16C illustrate a simplified example of a two wheel landing gear system having a forward drag brace. FIG. 16D illustrates a dual twin landing gear system with a forward drag brace. FIG. 16E illustrates a dual twin tandem landing gear system with a forward drag brace. FIG. 16F illustrates an articulating dual twin landing gear system with a forward drag brace. And FIG. 16G illustrates a dual twin landing gear system with an aftward drag brace.

FIGS. 16A, 16B, and 16C are side, rear, and top views, respectively, of a simplified landing gear system that includes an inboard wheel 1601 and an outboard wheel 1602 separately carried by a lower lateral support 1660. The lower lateral support 1660 is positioned in a landing gear cutout 1699 in a fuselage (also referred to herein as just the fuselage 1699 for simplicity) and connected to the fuselage at a forward location in the cutout 1699 via a drag brace, at a lateral location in the cutout 1699 via a lateral brace 1640, and at an upper location in the cutout 1699 via an upper hinge location B of an upper lateral support 1690. In addition, or alternatively, the drag brace can reside within a sponson fairing that covers the whole gear assembly externally. FIG. 16A shows the typical landing force vectors experienced by the wheels 1601, 1602, vertical (LF_{z}) and longitudinal (LFₓ, e.g., drag), and FIGS. 16B and 16C also show the lateral landing forces (LFₓ). Considering FIG. 16A, the upper and lower supports 1610, 1660 react the vertical landing force (LF_{z}) to the upper hinge location B, which results in a vertical force (indicated by arrow F_{z}) on the fuselage and the lower support 1660 reacts the longitudinal landing force (LFₓ) to the fuselage via the drag brace 1690. Additionally, the vertical offset between the location of the wheels 1601, 1602 and upper hinge location B can generate a lateral moment (M_{y}) about the upper hinge location B. This is resisted by a reaction of longitudinal Fₓ forces by the drag brace 1690 and the lateral brace 1640. In some examples, Hinge B is not capable of reacting longitudinal forces and is only capable of reacting lateral (F_{y}) and vertical (F_{z}) forces. On the other hand, as shown in FIGS. 15A and 15B, a hinge point capable of rotating about the Y axis, such as the one at the upper end of the secondary upper support members 1531, 1532 is capable of reacting longitudinal (Fₓ) forces.

FIG. 16B shows the upper lateral support 1610 in more detail, including separate inboard and outboard coupling locations with the lower lateral support 1660. The upper lateral support 1610 is able to rotate about the upper hinge location B, which means that upper hinge location B does not resist Mₓ, as caused by the lateral landing forces (LFₓ), which are instead resisted by the lateral brace 1640 as a lateral force (indicated by arrow F_{y}) reacted to the fuselage floor.

FIG. 16C shows a top-down view of the lower lateral support 1660 and visually illustrates how the longitudinal landing forces (LFₓ) on the wheels 1601, 1602 are reacted to the fuselage via the lateral brace 1640 and the drag brace 1690. In some examples, the lateral brace 1640 and the drag brace 1690 are coupled to the lower lateral support 1660 (or, in other instances, to the upper lateral support, or both) such that the drag brace 1690 and lateral brace 1640 together react the majority of the longitudinal landing forces (LFₓ) to the fuselage. Additionally, asymmetries in the longitudinal landing forces (LFₓ) on the wheels 1601, 1602 and/or in the location of the vertical axis A passing through the upper hinge location B (e.g., the axis about which the lower lateral support 1660 would twist in response to asymmetries in the longitudinal landing forces (LFₓ) without the presence of the lateral and drag braces) with respect to the wheels can generate a vertical moment (M_{z}) about vertical axis A. This vertical moment (M_{z}) is reacted by the bracing effect of the drag brace 1690 on the outboard side of the lower lateral support 1660 and the lateral brace on the inboard side of the lower lateral support 1660. Together the drag brace 1690 and the lateral brace 1640 can effectively prevent the longitudinal landing forces (LFₓ) on the wheels 1601, 1602 from inducing rotation of the lower lateral support 1660 about the vertical axis A. The drag brace 1690, when in tension (to agree with the direction of the landing forces, as illustrated), reacts a longitudinal force (as indicated by arrow Fₓ) and a lateral force (as indicated by arrow F_{y} to indicate that the primary lateral forces can be reacted by the lateral brace 1640). The lateral brace reacts a longitudinal force (as indicated by arrow F_{x′} to indicate that the primary longitudinal force can be reacted by the drag brace 1690) and a lateral force (as indicated by arrow F_{y}). The angles, with respect to the fuselage and/or the landing forces (e.g., the wheel orientation) of the drag brace 1690 and the lateral brace 1640 can be adjusted to make a corresponding adjustment in the distribution of longitudinal and lateral reaction forces transferred to the fuselage.

Notably, while examples disclosed herein utilize support assemblies able to rotate about a forward-aft axis and are stabilized by a lateral brace, this arrangement is not required to be implemented to utilize the drag brace aspects disclosed herein. However, the ability of the drag brace 1690 to reduce the need to strengthen the upper landing gear connections to resist M_{y} naturally synergizes with the ability of the lateral brace 1640 to reduce the need to stiffen any upper landing gear connections to resist Mₓ, thus the examples presented herein utilize both drag and lateral braces to stabilize the landing gear support assembly and reduce the complexity, robustness, and weight of the upper connections between the landing gear assembly and the fuselage.

FIG. 16D is a top view schematic of another example aircraft landing gear assembly having dual twin landing gears. In FIG. 16D a single lateral support member 1610 is used to carry dual inboard and outboard landing gear and couple them to the fuselage 1699 via an upper connection B. A drag brace 1690′ is connected to the lateral support member 1610 at a location approximate to the connection between the outboard dual landing gear and the lateral support member 1610. In practice, the location of the upper connection B can vary, and may not be in the center of the inboard and outboard landing gear, as shown.

Accordingly, a complex relationship exists between the location of the upper connection B, the lateral brace 1640, the outboard landing gear connection and the connection of the drag brace 1690′. Stated another way, with the drag brace removed, the lateral support member 1610 is statically fixed by the upper hinged connection B and the lateral brace 1640 (which may permit pivoting of the lateral support member). Thus, with the drag brace removed, drag on the outboard landing gear induces forces and moments on the upper hinged connection B (to resist the lateral support member pivoting about the lateral brace) that may be structurally inefficient to resist (e.g., require a connection of significant stiffness and weight). Therefore, the purpose of the drag brace 1690′ is to, in combination with the lateral brace 1614, rotationally fix the lateral support member 1610 about the vertical axis A, thereby preventing the upper hinged connection from experiencing effectively no moments about the vertical axis A.

Generally, any connection of the drag brace 1690′ with the lateral support member 1610 can statically fix the lateral support member 1610 and prevent rotation about the vertical axis A, however moving the connection of the drag brace 1690′ outboard increases the structural effectiveness of this static fixing by reducing the strength of the lateral support member 1610 necessary to transmit the drag forces laterally to the drag brace. Therefore, laterally aligning the connection of the drag brace 1690′ to the lateral support member 1610 with the connection between the outboard dual landing gear to the lateral support member 1610 maximizes the efficiency of the transmission of landing forces transmitted by the outboard landing gear to the drag brace 1690′. However, certain landing gear system structural arrangements using a drag brace as disclosed herein may not be configured to permit this exact attachment location.

FIG. 16E is a top view schematic of still another example aircraft landing gear assembly having dual twin tandem landing gears. Compared with FIG. 16D, the landing gear system of FIG. 16E includes a tandem configuration with a forward lateral support member 1610′ carrying a forward set of inboard and outboard landing gear and an aft lateral support member 1611′ carrying a second set of inboard and outboard landing gear. An aft lateral brace 1642 couples the inboard end of the aft lateral support member 1611′ to the fuselage 1699, a forward lateral brace 1641 couples the inboard end of the forward lateral support member 1610′ to the fuselage 1699, and an inboard longitudinal support member 1643 couples the forward and aft lateral braces 1641, 1642 together such that rotation of the landing gear assembly in the X-Y plane is prevented. A drag brace 1690′ connects the outboard end of the forward lateral support member 1610′ to the fuselage 1699 and a longitudinal support member 1650′ connects the outboard end of the forward lateral support member 1610′ to the outboard end of the aft lateral support member 1611′, thereby enabling the transfer of outboard longitudinal forces between the forward and aft lateral support members 1610′, 1611′. Each of the forward and aft lateral support members 1610′, 1611′ has a respective upper hinged connection B, B′ and a corresponding vertical axis A, A′ extending therethrough and about which rotation of the respective forward or aft lateral support member 1610′, 1611′ is prevented by the drag brace 1690′ and the longitudinal support member 1650′.

FIG. 16F is a top view schematic of yet another example aircraft landing gear assembly having dual twin tandem landing gears. In FIG. 16F, separate forward and aft inboard and outboard dual landing gears are carried by a lower supper assembly, which can include the two separate lower support members of the landing gear assembly 1500 of FIG. 15A, such that the lower super assembly articulates all of the landing gear as a single unit with respect to an upper support assembly that carries the vertical landing forces to the fuselage 1699. In FIG. 16F, the lower super assembly includes forward and aft lower lateral supports 1661, 1662 that are separately connected at the inboard ends to the fuselage via lateral braces 1641, 1642, and connected to each other at the outboard ends via a longitudinal linkage 1650″ such that the entire lower super assembly is coupled to the fuselage 1699 via a drag brace that is connected to the lower super assembly at the outboard end and coupled with the fuselage forward and inboard of the landing gear assembly. Alternatively, and as shown in FIG. 16G, examples of the drag brace include an aftward-extending drag brace 1690″ that can couple the outboard end of a lateral support 1610″ that is separately carrying inboard and outboard landing gear. In the aftward-extending configuration, the drag brace 1690″ extends aftwards and inboard from the outboard end of the lateral support 1610″ such that longitudinal landing forces on the landing gear are reacted through the drag brace 1690″ to the fuselage 1699 in compression.

FIGS. 18A and 18C show the primary forces reacted by the landing gear system 1500 to the fuselage during a landing operation. In FIG. 18A, vertical landing forces (e.g., LFz of FIG. 16A) on the inboard landing gear 1501 and the outboard landing gear 1502 can be reacted, as indicated by arrow F_{z}, vertically to the fuselage and lateral landing forces (e.g., LFy of FIG. 16B) can be reacted, as indicated by arrow F_{y} to the fuselage. In FIG. 18B, an alternate configuration of the landing gear system 1500′ is shown, with a single lateral spanning brace 1843 coupling the forward and aft lateral braces 1541′,1542′ together such that the inboard side of the landing gear system 1500′ is rigidly coupled to the fuselage, with rotation the forward and aft lateral braces 1541′,1542′ in the X-Y plane being prevented by the lateral spanning brace 1843. The forward and aft lateral braces 1541′,1542′ can still be each separately pinned to the primary upper support members 1511, 1512 to allow vertical rotation of the primary upper support member about the respective lateral brace, at least because this rotation is otherwise prevented by the outboard spanning brace 1550 and the drag brace 1590 securing the outboard ends of the primary upper support members 1511, 1512. Shown in FIG. 18B, for both the systems of FIGS. 18A and 18B, longitudinal landing forces (e.g., LFx of FIG. 16A) and lateral landing forces (e.g., LFy of FIG. 16B) are reacted to the fuselage as lateral forces (as indicated by arrows F_{y} and F_{y′}) and longitudinal forces (as indicated by arrows Fₓ and F_{x′}). Visible in FIG. 18B is the pivoted coupling 1591 between the drag brace 1590 and the outboard spanning brace 1550. Additionally, the lateral braces 1541, 1542 can be pivotably connected to their respective forward and aft primary upper support members 1511, 1512. FIG. 18C shows the vertical forces (as indicated by arrows F_{z} transferred to the fuselage via the upper hinges of the forward primary upper support member 1511 and an aft primary upper support member 1512. Shock absorbers 1569 direct forces from the articulating lower support members 1521, 1522 not carried by the primary upper support members 1511, 1512 to the secondary upper support members 1531, 1532, which are separately coupled to the fuselage with upper pinned connections 1831, 1832 that are configured to react forces directed along the secondary upper support members 1531, 1532 (as indicated by arrow F_{S} in FIG. 18C).

While FIGS. 9A-14C illustrate the floating main landing gear system as having two landing gear assemblies and FIGS. 15A-15C and 17-18C illustrate landing gear assemblies with four landing gear assemblies arranged as two inboard assemblies and two outboard assemblies, other configurations are possible, such as a single outboard landing gear assembly or three or more landing gear assemblies arranged, for example, as an inboard, an outboard, and a middle assembly. Examples also include having more than or less than two rows or tires in tandem as well, and examples of the drag brace include linking three or more landing gear bogies in tandem. Additionally, while the torque box examples are illustrated as having landing gear assemblies connected with a forward-facing wall, other configurations as possible, such as landing gear assemblies secured to a rear-facing wall, or any other part of the torque box. Also, while some examples presented herein show a single torque box on opposite sides of the aircraft, other configurations are possible, such as two or more torque boxes on either side of the aircraft. While the floating main landing gear system examples are illustrated in the context of a high-wing aircraft, the floating main landing gear system is equally suitable for use with other wing configurations, such as a low wing aircraft. While the floating main landing gear system is shown herein on a cargo aircraft, aspects are equally applicable to other types of aircraft, such as passenger and/or military aircraft. Also, while the landing gear systems of FIGS. 15A-18C illustrate a single drag brace, other configurations are possible, such as two or more separate drag braces, as well as configurations that have a single fuselage attachment point supporting two or more drag braces and, alternatively, a single landing gear support structure attachment point supporting two or more drag braces to the fuselage. And, while the landing gear systems of FIGS. 15A-18C illustrate a drag brace that extends in a substantially horizontal direction, this direction can have more of a vertical component in other example implementations such as to, for example, support a more downward deployment of the landing gear support structure. In such configurations, the drag brace can still be arranged to stay predominantly in tension during landing operations.

The examples of the landing gear systems show landing gear assemblies comprising wheels, however, equally possible are other landing systems, such as skis for arctic aircraft and/or pontoons for water-based aircraft. Moreover, aspects of the floating main landing gear system can be used with all forms of aircraft, such as vertical takeoff and landing aircraft. While aspects of the main landing gear systems are shown as structural elements, one skilled in the art will appreciate that a number of auxiliary electrical, hydraulic, and/or mechanical systems may be present to facilitate the functionality of the landing gear assemblies and/or other aspects of the floating main landing gear system, such as sensors on the hinges and/or static linkages to monitor structural performance.

While the static linkages, also referred to as tie-rods, are shown as discussed herein as fixed structures, other configurations are possible, such as shock absorbing elements and dampers, including variable dampers, which may be used and/or controlled in order to adapt the floating main landing gear system for certain landing and takeoff conditions or in real-time to control the forces transferred from the torque box to the lower fuselage.

The terms parallel, substantially parallel, and approximately parallel are used throughout and can refer to the same geometric limitation, which can be about +/−5 degrees with respect to each other.

One skilled in the art will appreciate further features and advantages of the disclosures based on the provided for descriptions and embodiments. Accordingly, the inventions are not to be limited by what has been particularly shown and described. For example, although the present disclosure provides for transporting large cargo, such as wind turbine parts, the present disclosures can also be applied to other types of large cargos or to smaller cargo. All publications and references cited herein are expressly incorporated herein by reference in their entirety.

Examples of the above-described embodiments can include the following:
1. An aircraft, comprising:
   a fuselage:
   a landing gear system comprising a drag brace, a lateral brace, and a support assembly having a lateral support element configured to separately carry an inboard landing gear and an outboard landing gear arranged substantially in parallel when in a deployed configuration, the support assembly:
      (i) coupled with the fuselage at an upper location with respect to the landing gear system via an upper hinged connection;
      (ii) coupled with the fuselage at a lateral location with respect to the landing gear system via the lateral brace; and
      (iii) coupled with the fuselage at a forward location with respect to the landing gear system via the drag brace, the drag brace coupled with the support assembly outboard of a connection between the lateral support element and the inboard landing gear,
   wherein the support assembly is configured to rotate about the upper hinged connection about a forward-aft axis,
   wherein the lateral brace is configured to resist rotation of the support assembly about the forward-aft axis, and
   wherein the drag brace is configured to resist rotation of the support assembly about a vertical axis.
2. The aircraft of example 1, wherein the drag brace is coupled with the support assembly outboard of a connection between the lateral support element and the inboard landing gear.
3. The aircraft of examples 1 or 2, wherein the drag brace is configured to resist rotation of the lateral support element about the vertical axis such that the longitudinal forces on the inboard and outboard landing gear result do not induce a vertical moment about the upper connection.
4. The aircraft of any of examples 1 to 3, wherein the drag brace is configured to resist rotation of the support assembly about the vertical axis such that an outboard end of the lateral support element is prevented from moving forward or aft.
5. The aircraft of any of examples 1 to 4,
   wherein the support assembly is configured to react vertical forces from the inboard and outboard landing gears to the fuselage,
   wherein the lateral brace is configured to react lateral forces from the inboard and outboard landing gears to the fuselage, and
   wherein the drag brace is configured to react longitudinal forces from the outboard landing gear to the fuselage.
6. The aircraft of any of examples 1 to 5, wherein, when carried by the support assembly, outboard landing gear comprises at least one wheel positioned outboard of the upper location.
7. The aircraft of any of examples 1 to 6, wherein, when carried by the support assembly, the inboard and outboard landing gears each comprise at least two separate wheels positioned substantially in parallel.
8. The aircraft of any of examples 1 to 7, wherein the lateral support element is arranged such that longitudinal forces on the outboard landing gear create a moment about the vertical axis that is resisted by the drag brace.
9. The aircraft of any of examples 1 to 8, wherein the drag brace is coupled with an outboard end of the lateral support element.
10. The aircraft of any of examples 1 to 9, wherein the landing gear system is configured to move the support assembly between a stowed position and the deployed position.
11. The aircraft of example 10, wherein the lateral support element comprises an upper support and kneeling support moveably coupled with the upper support, the kneeling support configured to separately carry the inboard landing gear and the outboard landing gear and is moveable with respect to the upper support to move the inboard and outboard landing gears between the deployed configuration and a partially-stowed configuration.
12. The aircraft of any of examples 1 to 11,
   wherein the support assembly comprises a forward lateral support element and an aft lateral support element,
   wherein the forward lateral support element is configured to react forces from the inboard and outboard landing gear assemblies, and
   wherein the aft lateral support element is configured to react forces from a second inboard landing gear assembly and a second outboard landing gear assembly separately carried by the aft lateral support element.
13. The aircraft of example 12 wherein the support assembly further comprises a longitudinal support element coupling the aft lateral support element to the forward lateral support element such that the forward and aft lateral support element rotate together about substantially parallel respective vertical axes.
14. An aircraft, comprising:
   a fuselage:
   a landing gear system comprising a drag brace, a lateral brace, and a support assembly with lateral support element configured to separately carry an inboard landing gear and an outboard landing gear arranged substantially in parallel when in a deployed configuration, the support assembly:
      (i) coupled with the fuselage at an upper location with respect to the landing gear system via an upper connection; and
      (ii) coupled with the fuselage at a forward location with respect to the landing gear system via the drag brace, the drag brace coupled with the lateral support element outboard of a connection between the lateral support element and the outboard landing gear,
   wherein the drag brace is configured to resist rotation of the lateral support element about a vertical axis such that the longitudinal forces on the inboard and outboard landing gear result do not induce a vertical moment about the upper connection.
15. The aircraft of example 14, wherein the drag brace is configured to resist rotation of the support assembly about the vertical axis such that an outboard end of the lateral support element is prevented from moving forward or aft.
16. The aircraft of example 14 or 15,
   wherein the support assembly is configured to react vertical forces from the inboard and outboard landing gears to the fuselage,
   wherein the lateral brace is configured to react lateral forces from the inboard and outboard landing gears to the fuselage, and
   wherein the drag brace is configured to react longitudinal forces from the outboard landing gear to the fuselage.
17. The aircraft of claim any of examples 14 to 16, wherein, when carried by the support assembly, outboard landing gear comprises at least one wheel positioned outboard of the upper location.
18. The aircraft of claim any of examples 14 to 17 wherein, when carried by the support assembly, the inboard and outboard landing gears each comprise at least two separate wheels positioned substantially in parallel.
19. The aircraft of claim any of examples 14 to 18, wherein the lateral support element is arranged such that longitudinal forces on the outboard landing gear create a moment about the vertical axis that is resisted by the drag brace.
20. The aircraft of claim any of examples 14 to 19, wherein the landing gear system is configured to move the support assembly between a stowed position and the deployed position.
21. The aircraft of claim any of examples 14 to 20,
   wherein the support assembly comprises a forward lateral support element and an aft lateral support element,
   wherein the forward lateral support element is configured to react forces from the inboard and outboard landing gear assemblies, and
   wherein the aft lateral support element is configured to react forces from a second inboard landing gear assembly and a second outboard landing gear assembly separately carried by the aft lateral support element.
22. A landing gear system for an aircraft, the assembly comprising:
   a drag brace,
   a lateral brace,
   a support assembly comprising a upper hinge and a lateral support element, the support assembly configured to be coupled to a fuselage of an aircraft via the upper hinge, the drag brace, and the lateral brace;
   an inboard landing gear coupled with the lateral support element and configured to support at least a portion of the weight of the aircraft; and
   an outboard landing gear separately coupled with the lateral support element and configured to support at least a portion of the weight of the aircraft,
   wherein the support assembly is configured to, in a deployed configuration, rotate about a forward-aft axis of the upper hinge with respect to the lateral side of the fuselage and react vertical forces from the inboard and outboard landing gears to the fuselage,
   wherein the lateral brace is configured to, in a deployed configuration, statically couple the support assembly to the fuselage such that rotation of the support assembly about the hinge is resisted by the lateral brace and react lateral forces from the inboard and outboard landing gears to the fuselage, and
   wherein the drag brace is configured to, in a deployed configuration, statically couple the support assembly to the fuselage such that rotation of the support assembly about a vertical axis is resisted by the drag brace and react longitudinal forces from the outboard landing gear to the fuselage.
23. The landing gear system of example 22, wherein the drag brace is configured to resist rotation of the support assembly about the vertical axis such that an outboard end of the lateral support element is preventing from moving aftward.
24. The landing gear system of examples 22 or 23,
   wherein the support assembly is configured to react vertical forces from the inboard and outboard landing gears to the fuselage,
   wherein the lateral brace is configured to react lateral forces from the inboard and outboard landing gears to the fuselage, and
   wherein the drag brace is configured to react longitudinal forces from the outboard landing gear to the fuselage.
25. The landing gear system of any of examples 22 to 24, wherein the outboard landing gear comprises at least one wheel positioned outboard of the upper location.
26. The landing gear system of any of examples 22 to 25, wherein the inboard and outboard landing gears each comprise at least two separate wheels arranged substantially in parallel.
27. The landing gear system of any of examples 22 to 26, wherein the lateral support element is arranged such that longitudinal forces on the outboard landing gear create a moment of the lateral support element about the vertical axis that is resisted by the drag brace.
28. The landing gear system of any of examples 22 to 27, wherein the drag brace is coupled with an outboard end of the lateral support element.
29. The landing gear system of any of examples 22 to 28, wherein the lateral support element comprises an upper support and kneeling support moveably coupled with the upper support, the kneeling support configured to separately carry the inboard landing gear and the outboard landing gear and is moveable with respect to the upper support to move the inboard and outboard landing gears between the deployed configuration and a partially stowed configuration.
30. The landing gear system of any of examples 22 to 29, wherein the support assembly comprises a forward lateral support element and an aft lateral support element, and wherein the forward lateral support element is configured to react forces from the inboard and outboard landing gear assemblies, and wherein the aft lateral support element is configured to react forces from a second inboard landing gear assembly and a second outboard landing gear assembly separately carried by the aft lateral support element.
31. The landing gear system of example 30, wherein the support assembly further comprises a longitudinal support element coupling the aft lateral support element to the forward lateral support element such that the forward and aft lateral support element rotate together about substantially parallel respective vertical axes.
32. A cargo aircraft, comprising:
   a fuselage defining a forward end, an aft end, and a continuous interior cargo bay that spans a majority of a length of the fuselage from the forward end to the aft end; and
   a landing gear system comprising a drag brace, a lateral brace, and a support assembly including a lateral support element configured to separately carry an inboard landing gear and an outboard landing gear, the support assembly coupled with the fuselage via: (i) an upper hinged connection; (ii) the lateral brace; and (iii) the drag brace,
   wherein the support assembly is configured to rotate about a forward-aft axis of the upper hinged connection,
   wherein the lateral brace is configured to resist rotation of the support assembly about the upper hinged connection,
   wherein the drag brace is configured to resist rotation of the support assembly about a vertical axis such that the longitudinal forces on the inboard and outboard landing gear do not induce a vertical moment about the upper connection, and
   wherein the upper hinged connection is configured to direct vertical loads from the support assembly into at least one of a skin of the fuselage or a transverse frame of the fuselage.
33. The cargo aircraft of example 32, wherein the landing gear system is a first landing gear system and the aircraft comprising a second landing gear system, the first landing gear system arranged on a first lateral side of the cargo aircraft and the second landing gear system arranged on a second opposite lateral side of the cargo aircraft.
34. The cargo aircraft of examples 32 or 33, wherein the first landing gear system and the second landing gear system together define at least a portion of a main landing gear of the cargo aircraft, the main landing gear being positioned closer to a center of gravity of the cargo aircraft than any other landing gear.
35. The cargo aircraft of example 32, the fuselage further comprising:
   a forward portion containing a forward region of the continuous interior cargo bay, the forward portion defining a forward centerline along a longitudinal-lateral plane of the cargo aircraft;
   an aft portion containing an aft region of the continuous interior cargo bay, the aft portion defining an aft centerline extending above the longitudinal-lateral plane of the cargo aircraft; and
   a kinked portion forming a junction in the fuselage between the forward portion and the aft portion of the fuselage and between the forward and aft regions of the continuous interior cargo bay, the kinked portion containing a transition region of the continuous interior cargo bay and defining a bend angle between the forward centerline and the aft centerline,
   wherein the landing gear system is located in the forward portion of the fuselage.
36. An aircraft, comprising:
   a fuselage; and
   a floating landing gear system comprising a torque box configured to support a landing gear assembly, the torque box coupled with a lateral side of the fuselage via an upper hinged connection and coupled with a lower side of the fuselage via a lower static coupling;
   wherein the torque box is configured to rotate about a forward-aft axis of the upper hinged connection, and
   wherein the lower static coupling is configured to resist rotation of the torque box about the upper hinged connection.
37. The aircraft of example 36, wherein the floating landing gear system comprises at least one landing gear assembly coupled with the torque box.
38. The aircraft of example 37, wherein the at least one landing gear assembly comprises:
   an outer landing gear assembly disposed laterally outside with respect to the hinge; and
   an inner landing gear assembly disposed laterally inside with respect to the hinge.
39. The aircraft of example 37, wherein the at least one landing gear assembly is configured to apply a combined vertical force to the torque box that is laterally offset from a vertical location of the hinge.
40. The aircraft of any of examples 36 to 39, wherein the upper hinged connection defines a single rotation axis that is approximately parallel to the lateral side of the fuselage.
41. The aircraft of any of examples 36 to 40,
   wherein the fuselage comprises a landing gear wheel well formed in the lateral side of the fuselage, and
   wherein at least an inner lateral end of the torque box is disposed within the landing gear wheel well.
42. The aircraft of any of examples 36 to 41, wherein the floating landing gear system is a first floating landing gear system and the aircraft comprising a second floating landing gear system, the first floating landing gear system arranged on a first lateral side of the aircraft and the second floating landing gear system arranged on a second opposite lateral side of the aircraft.
43. The aircraft of example 42, wherein the first floating landing gear system and the second floating landing gear system together define at least a portion of a main landing gear of the aircraft, the main landing gear being positioned closer to a center of gravity of the aircraft than any other landing gear.
44. The aircraft of any of examples 36 to 43, wherein the upper hinged connection is configured to direct vertical forces from the torque box into the lateral side of the fuselage.
45. The aircraft of example 44, wherein the upper hinged connection comprises a clevis fastener configured to transfer the vertical forces from the torque box into the lateral side of the fuselage.
46. The aircraft of examples 44 or 45, wherein the clevis fastener is configured to transfer lateral forces from the torque box into the lateral side of the fuselage.
47. The aircraft of any of examples 44 to 46, wherein the upper hinged connection is configured to direct longitudinal forces from the torque box into the lateral side of the fuselage.
48. The aircraft of example 47, wherein the upper hinged connection comprises a piano hinge element configured to transfer the longitudinal forces from the torque box into the lateral side of the fuselage.
49. The aircraft of any of examples 36 to 48, wherein the lower static coupling is configured to convert moments about the hinged connection into tangential forces on at least one of the skin of the fuselage or the transverse frame of the fuselage.
50. The aircraft of any of examples 36 to 49, wherein the upper hinged connection is configured to direct forces from the torque box into at least one of a skin of the lateral side of the fuselage or a transverse frame element of the lateral side of the fuselage.
51. The aircraft of any of examples 36 to 50, wherein the lower static coupling is configured to direct forces from the torque box into at least one of a skin of the lower side of the fuselage or a transverse frame element of the lower side of the fuselage.
52. The aircraft of any of examples 36 to 51, wherein the static coupling element comprises a tie-rod linkage.
53. The aircraft of any of examples 36 to 52, wherein the hinge is laterally offset from the static coupling element.
54. A cargo aircraft, comprising:
   a fuselage defining a forward end, an aft end, and a continuous interior cargo bay that spans a majority of a length of the fuselage from the forward end to the aft end; and
   a floating landing gear system comprising a torque box configured to support a landing gear assembly, the torque box coupled with a lateral side of the fuselage via an upper hinged connection and coupled with a lower side of the fuselage via a lower static coupling;
   wherein the rocker is configured to rotate about the upper hinged connection,
   wherein the lower static coupling is configured to resist rotation of the torque box about the upper hinged connection,
   wherein the upper hinged connection is configured to direct vertical loads from the rocker into at least one of a skin of the fuselage or a transverse frame of the fuselage, and
   wherein the lower static coupling is configured to convert moments about the hinged connection into tangential forces on at least one of the skin of the fuselage or the transverse frame of the fuselage.
55 The cargo aircraft of example 54, wherein the floating landing gear system is a first floating landing gear system and the aircraft comprising a second floating landing gear system, the first floating landing gear system arranged on a first lateral side of the cargo aircraft and the second floating landing gear system arranged on a second opposite lateral side of the cargo aircraft.
56. The cargo aircraft of example 55, wherein the first floating landing gear system and the second floating landing gear system together define at least a portion of a main landing gear of the cargo aircraft, the main landing gear being positioned closer to a center of gravity of the cargo aircraft than any other landing gear.
57. The cargo aircraft of any of examples 54 to 56, the fuselage further comprising:
   a forward portion containing a forward region of the continuous interior cargo bay, the forward portion defining a forward centerline along a longitudinal-lateral plane of the cargo aircraft;
   an aft portion containing an aft region of the continuous interior cargo bay, the aft portion defining an aft centerline extending above the longitudinal-lateral plane of the cargo aircraft; and
   a kinked portion forming a junction in the fuselage between the forward portion and the aft portion of the fuselage and between the forward and aft regions of the continuous interior cargo bay, the kinked portion containing a transition region of the continuous interior cargo bay and defining a bend angle between the forward centerline and the aft centerline,
   wherein the floating landing gear system is located in the forward portion of the fuselage.
58. The cargo aircraft of any of examples 54 to 47, wherein the length of the fuselage is greater than about 84 meters, and wherein the continuous interior cargo bay defines a maximum payload length of at least about 70 meters.
59. A floating landing gear system for an aircraft, the assembly comprising:
   a torque box comprising a hinge and a static coupling element, the torque box configured to be coupled to a lateral side of a fuselage of an aircraft via the hinge and configured to be coupled to a lower side of the fuselage via the static coupling element; and
   at least one landing gear assembly coupled to the torque box and configured to support at least a portion of the weight of the aircraft,
   wherein the torque box is configured to rotate about the hinge with respect to the lateral side of the fuselage,
   wherein the static coupling element is configured to statically couple the torque box to the lower side of the fuselage such that rotation of the torque box about the hinge is resisted by the static coupling element, and
   wherein the hinge is configured to transfer vertical, lateral, and longitudinal forces from the at least one landing gear assembly to the lateral side of the fuselage.
60. The floating landing gear system of example 59, wherein the at least one landing gear assembly is configured to apply a combined vertical force to the torque box that is laterally offset from a vertical location of the hinge.
61. The floating landing gear system of examples 59 or 60, wherein the hinge is configured to rotatably couple the torque box to the lateral side of the fuselage about a single axis approximately parallel to at least one of a longitudinal axis of the aircraft or the lateral side of the fuselage.
62. The floating landing gear system of any of examples 59 to 61, wherein the hinge comprises a piano hinge or compliant flexure element configured to transfer the longitudinal forces from the at least one landing gear assembly to the lateral side of the fuselage.
63. The floating landing gear system of any of examples 59 to 62, wherein the hinge comprises a clevis fastener configured to transfer the vertical and lateral forces from the at least one landing gear assembly to the lateral side of the fuselage.
64. The floating landing gear system of any of examples 59 to 63, wherein the hinge is laterally offset from the static coupling element.
65. The floating landing gear system of example 64, wherein the hinge is disposed about an upper end of the torque box and the static coupling element is disposed about a lower end of the torque box.
66. The floating landing gear system of any of examples 59 to 65, wherein the static coupling element comprises a tie-rod linkage.
67. The floating landing gear system of any of examples 59 to 66, wherein the at least one landing gear assembly comprises an outer landing gear assembly disposed laterally outside with respect to the hinge and an inner landing gear assembly disposed laterally inside with respect to the hinge.
68. The floating landing gear system of any of examples 59 to 67, wherein the at least one landing gear assembly defines a deployed configuration and a stowed configuration and the at least one landing gear assembly is moveable between the deployed and stowed configurations.

1. An aircraft, comprising:
a fuselage:
a landing gear system comprising a drag brace, a lateral brace, and a support assembly having a lateral support element configured to separately carry an inboard landing gear and an outboard landing gear arranged substantially in parallel when in a deployed configuration, the support assembly:
(i) coupled with the fuselage at an upper location with respect to the landing gear system via an upper hinged connection;
(ii) coupled with the fuselage at a lateral location with respect to the landing gear system via the lateral brace; and
(iii) coupled with the fuselage at a forward location with respect to the landing gear system via the drag brace, the drag brace coupled with the support assembly outboard of a connection between the lateral support element and the inboard landing gear,
wherein the support assembly is configured to rotate about the upper hinged connection about a forward-aft axis,
wherein the lateral brace is configured to resist rotation of the support assembly about the forward-aft axis, and
wherein the drag brace is configured to resist rotation of the support assembly about a vertical axis.

2. The aircraft of claim 1, wherein the drag brace is coupled with the support assembly outboard of a connection between the lateral support element and the inboard landing gear.

3. The aircraft of claim 1, wherein the drag brace is configured to resist rotation of the lateral support element about the vertical axis such that the longitudinal forces on the inboard and outboard landing gear result do not induce a vertical moment about the upper connection.

4. The aircraft of claim 1, wherein the drag brace is configured to resist rotation of the support assembly about the vertical axis such that an outboard end of the lateral support element is prevented from moving forward or aft.

5. The aircraft of claim 1,
wherein the support assembly is configured to react vertical forces from the inboard and outboard landing gears to the fuselage,
wherein the lateral brace is configured to react lateral forces from the inboard and outboard landing gears to the fuselage, and
wherein the drag brace is configured to react longitudinal forces from the outboard landing gear to the fuselage.

6. (canceled)

7. The aircraft of claim 1, wherein, when carried by the support assembly, the inboard and outboard landing gears each comprise at least two separate wheels positioned substantially in parallel.

8. The aircraft of claim 1, wherein the lateral support element is arranged such that longitudinal forces on the outboard landing gear create a moment about the vertical axis that is resisted by the drag brace.

9. The aircraft of claim 1, wherein the drag brace is coupled with an outboard end of the lateral support element.

10. (canceled)

11. (canceled)

12. The aircraft of claim 1,
wherein the support assembly comprises a forward lateral support element and an aft lateral support element,
wherein the forward lateral support element is configured to react forces from the inboard and outboard landing gear assemblies, and
wherein the aft lateral support element is configured to react forces from a second inboard landing gear assembly and a second outboard landing gear assembly separately carried by the aft lateral support element.

13. The aircraft of claim 12 wherein the support assembly further comprises a longitudinal support element coupling the aft lateral support element to the forward lateral support element such that the forward and aft lateral support element rotate together about substantially parallel respective vertical axes.

14. An aircraft, comprising:
a fuselage:
a landing gear system comprising a drag brace, a lateral brace, and a support assembly with lateral support element configured to separately carry an inboard landing gear and an outboard landing gear arranged substantially in parallel when in a deployed configuration, the support assembly:
(i) coupled with the fuselage at an upper location with respect to the landing gear system via an upper connection; and
(ii) coupled with the fuselage at a forward location with respect to the landing gear system via the drag brace, the drag brace coupled with the lateral support element outboard of a connection between the lateral support element and the outboard landing gear,
wherein the drag brace is configured to resist rotation of the lateral support element about a vertical axis such that the longitudinal forces on the inboard and outboard landing gear result do not induce a vertical moment about the upper connection.

15. The aircraft of claim 14, wherein the drag brace is configured to resist rotation of the support assembly about the vertical axis such that an outboard end of the lateral support element is prevented from moving forward or aft.

16. The aircraft of claim 14,
wherein the support assembly is configured to react vertical forces from the inboard and outboard landing gears to the fuselage,
wherein the lateral brace is configured to react lateral forces from the inboard and outboard landing gears to the fuselage, and
wherein the drag brace is configured to react longitudinal forces from the outboard landing gear to the fuselage.

17-21. (canceled)

22. A landing gear system for an aircraft, the assembly comprising:
a drag brace,
a lateral brace,
a support assembly comprising a upper hinge and a lateral support element, the support assembly configured to be coupled to a fuselage of an aircraft via the upper hinge, the drag brace, and the lateral brace;
an inboard landing gear coupled with the lateral support element and configured to support at least a portion of the weight of the aircraft; and
an outboard landing gear separately coupled with the lateral support element and configured to support at least a portion of the weight of the aircraft,
wherein the support assembly is configured to, in a deployed configuration, rotate about a forward-aft axis of the upper hinge with respect to the lateral side of the fuselage and react vertical forces from the inboard and outboard landing gears to the fuselage,
wherein the lateral brace is configured to, in a deployed configuration, statically couple the support assembly to the fuselage such that rotation of the support assembly about the hinge is resisted by the lateral brace and react lateral forces from the inboard and outboard landing gears to the fuselage, and
wherein the drag brace is configured to, in a deployed configuration, statically couple the support assembly to the fuselage such that rotation of the support assembly about a vertical axis is resisted by the drag brace and react longitudinal forces from the outboard landing gear to the fuselage.

23. The landing gear system of claim 22, wherein the drag brace is configured to resist rotation of the support assembly about the vertical axis such that an outboard end of the lateral support element is preventing from moving aftward.

24. The landing gear system of claim 22,
wherein the support assembly is configured to react vertical forces from the inboard and outboard landing gears to the fuselage,
wherein the lateral brace is configured to react lateral forces from the inboard and outboard landing gears to the fuselage, and
wherein the drag brace is configured to react longitudinal forces from the outboard landing gear to the fuselage.

25-27. (canceled)

28. The landing gear system of claim 22, wherein the drag brace is coupled with an outboard end of the lateral support element.

29. (canceled)

30. The landing gear system of claim 22, wherein the support assembly comprises a forward lateral support element and an aft lateral support element, and wherein the forward lateral support element is configured to react forces from the inboard and outboard landing gear assemblies, and wherein the aft lateral support element is configured to react forces from a second inboard landing gear assembly and a second outboard landing gear assembly separately carried by the aft lateral support element.

31. The landing gear system of claim 30, wherein the support assembly further comprises a longitudinal support element coupling the aft lateral support element to the forward lateral support element such that the forward and aft lateral support element rotate together about substantially parallel respective vertical axes.

32. A cargo aircraft, comprising:
a fuselage defining a forward end, an aft end, and a continuous interior cargo bay that spans a majority of a length of the fuselage from the forward end to the aft end; and
a landing gear system comprising a drag brace, a lateral brace, and a support assembly including a lateral support element configured to separately carry an inboard landing gear and an outboard landing gear, the support assembly coupled with the fuselage via: (i) an upper hinged connection; (ii) the lateral brace; and (iii) the drag brace,
wherein the support assembly is configured to rotate about a forward-aft axis of the upper hinged connection,
wherein the lateral brace is configured to resist rotation of the support assembly about the upper hinged connection,
wherein the drag brace is configured to resist rotation of the support assembly about a vertical axis such that the longitudinal forces on the inboard and outboard landing gear do not induce a vertical moment about the upper connection, and
wherein the upper hinged connection is configured to direct vertical loads from the support assembly into at least one of a skin of the fuselage or a transverse frame of the fuselage.

33-68. (canceled)
